(19) United States
(12) Patent Application Publication
(10) Pub. No.: US 2002/0131404 A1
(43) Pub. Date: Sep. 19, 2002

(54) Method and system for maintaining and distributing wireless applications

(75) Inventors: Samir Narendra Mehta, Renton, WA (US); Mazin Ramadan, Seattle, WA (US); Zeyad Ramadan, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: 4thpass Inc., Seattle, WA (US)

(21) Appl. No.: 09/997,402

(22) Filed: Nov. 28, 2001

Related U.S. Application Data
(60) Provisional application No. 60/253,674, filed on Nov. 28, 2000.
(60) Provisional application No. 60/271,661, filed on Feb. 26, 2001.
(60) Provisional application No. 60/296,901, filed on Jun. 8, 2001.
(60) Provisional application No. 60/296,872, filed on Jun. 8, 2001.

(51) Int. Cl. H04L 12/28

(52) U.S. Cl. 370/352; 370/351

(57) ABSTRACT

Computer- and network-based methods and systems for maintaining and provisioning wireless applications are provided. Example embodiments provide a Mobile Application System (MAS), which is a collection of interoperating server components that work individually and together in a secure fashion to provide applications and resources to mobile subscriber devices, such as wireless devices. Embodiments of the present invention can also be used to deploy applications and resources for wired subscriber devices. Application, resources, and other content is provisioned and verified by the MAS for authorized access by the subscriber, compatibility with a requesting subscriber device, and the security and billing policies of the carrier and system administrators of the MAS. In this manner, applications, resources, and other content can be downloaded to devices, such as wireless devices, with greater assurance of their ability to successfully execute. In one embodiment, content is provisioned by one or more of the steps of inspecting the content for malicious or banned code, optimizing the content for smaller size and greater speed, instrumentation of code that implements security, billing, and other carrier policies, and packaging of code for the intended subscriber device. Additional security is provided through application filters that are used to prevent applications that contain designated API from being downloaded to a subscriber's device. In one embodiment, the MAS includes a Protocol Manager, Provisioning Manager, Cache, Deployment Manager, Billing Manager, Logging Manager, Administrator, and Heartbeat Monitor, which interoperate to provide the provisioning functions.

### BACKGROUND OF THE INVENTION

1. Field of the Invention

The present invention relates to a method and system for wireless applications and, in particular, to methods and systems for maintaining and distributing wireless applications to wireless devices over a wireless network.

2. Background Information

Today, wireless devices have become prolific in many communities of the world. Devices such as wireless phones, handsets, personal information managers, electronic organizers, personal digital assistants, portable e-mail machines, game machines, and other devices are used by subscribers of telephone carriers to add convenience to our lives. However, the software used on such devices and the mechanisms for deploying such software to these devices are arcane. Typically, a customer, for example, of a cellular phone service, must bring the cellular phone into a vendor of the cellular phone service to have new or updated service software or capabilities loaded onto the phone. In addition, even changes to a customer's subscription are processed on location or by calling up a customer service representative. Furthermore, because each carrier is physically responsible for distributing services and applications, each carrier must test services and applications it wishes to offer on the devices that it designates as operable. Content providers, who wish to develop applications for such wireless devices, must do so for each device they wish to support, and, in potentially in conjunction with the carriers and device manufacturers, must test such applications. Moreover, if a particular software application doesn't operate properly, the carrier must recall all of the physical devices to update the software. Thus, there is an escalating need for deploying software more easily to wireless devices.

### BRIEF SUMMARY OF THE INVENTION

Embodiments of the present invention provide computer- and network-based methods and systems for maintaining and provisioning wireless applications. Example embodiments provide a Mobile Application System (MAS), which is a collection of interoperating server components that work individually and together in a secure fashion to provide applications, resources, and other content to mobile subscriber devices, such as wireless devices. Embodiments of the present invention can also be used to deploy applications and other content for wired subscriber devices as well. Application, resources, and other content is provisioned and verified by the MAS for authorized access by the subscriber, compatibility with a requesting subscriber device, and/or compliance with security and billing policies of the carrier and system administrators of the MAS. In this manner, applications, resources, and other content can be downloaded to devices, such as wireless devices, with greater assurance of their ability to successfully execute.

In some embodiments, the MAS provides the ability to submit new content, request downloads of content and application discovery. In some embodiments, application discovery returns a list of content that can be downloaded that match criteria that are designated by the subscriber. In other embodiments, the MAS returns a list of content based upon subscriber preferences. In some embodiments, subscriber preferences are managed through a personal access list.

In one embodiment, the verification process for submitting content, for downloading content, and for application discovery comprises one or more of verifying that the subscriber is authorized to use the content under the billing policy associated with the subscriber, verifying that the device can support the API and resource requirements of the content, and verifying that the content is not banned from use. In some embodiments, verification is performed through profiles, which can be administered through the system. In one embodiment, the verification that the device can support the content is determined by comparing an application profile associated with the content with a device profile that is associated with the subscriber's device. In some embodiments, the list provided to the subscriber device during application discovery is filtered to display only content that has been verified according to these procedures.

In one embodiment of the MAS, walled-garden provisioning is provided. Content is submitted to the MAS, inspected for malicious or banned code, or for the presence of particular API, approved, and published by the MAS. Subscribers can then discover and request the content. In some embodiments, the published content is preprovisioned (static provisioning). In other embodiments, the published content is provisioned dynamically upon download request.

In another embodiment, open provisioning is provided. With open provisioning, a subscriber browses to a site on a network, such as the Internet, and specifies a request to download content at a particular address, for example, a URL. The MAS intercepts this request, downloads the content from the address, and inspects the content for API or other attributes that should not appear in the content. If the inspection is successful, the MAS provisions the content for the subscriber. In one embodiment, the inspection process is performed using application filters. In some embodiments, the requested content is also verified for the subscriber's device to increase the likelihood that the content will execute properly on the device.

In one embodiment, content is provisioned by one or more of the steps of inspecting the content for designated code, optimizing the content for smaller size and greater speed, instrumenting code that implements security, billing, usage, or other carrier policies, and packaging code for the intended subscriber device. In one embodiment, the content is inspected for malicious or banned code or for the use of specified API. In another embodiment, code is inspected for misbehaving or forbidden API. In some embodiments the code inspection compares the content with a list of package, class, method, or field names. In some embodiments, the comparison is performed at the bytecode level. In other embodiments, the comparison is performed at other levels such as the source code level. In some embodiments, application filters are used to drive the code inspection process. Application filters can specify parameters, code names, API, or other attributes of content that are banned from use for a particular target. In one embodiment, targets include a specific application or other content, a specific content provider, device type, or subscriber, or all such applications, content providers, devices, or subscribers.

During the provisioning process, content is instrumented with additional code as needed by policies of the carrier, MAS, and/or a system administrator. In some embodiments, code is instrumented at the byte-code level. In yet other embodiments, code is instrumented at levels other than the byte-code level. In some embodiments, the instrumented code provides one or more of code to implement payment or billing policies, code to notify subscribers of untrusted or potentially unsecure content, code to provide automatic notification to users when updates are available for downloaded content.

During the provisioning process, the inspected, optimized, or instrumented content can be packaged appropriate to the requesting device. In some other embodiments, the packaging compresses the content. In yet other embodiments, the packaging breaks up the provisioned content into smaller packages that can be reassembled on the subscriber device.

In another embodiment, the MAS supports a variety of security policies and mechanisms. Application filters can be created and managed that are used during the inspection process. In some embodiments, these filters are used to inspect code during submission and during provisioning. In yet another embodiment, a list of banned applications is provided that prevents subscribers from downloading content that has been dynamically banned by a carrier. In some embodiments this list is used during verification process. In yet other embodiments, security code is incorporated at various levels of the MAS to provide secure communication mechanisms, such as encryption, secure messaging, etc.

In yet another embodiment, the MAS provides for a variety of billing methods and policies. In one embodiment, the methods include billing options such as a charge for downloading an application, a subscription charge based upon a periodic fees, trial use for a designated period or time, and packet-based billing charges based upon transmissions of network packets. In addition, in another embodiment the MAS supports pre-paid billing for downloading applications according to one or more of the billing options listed.

In one embodiment, the MAS includes a Protocol Manager, Provisioning Manager, Cache, Deployment Manager, Billing Manager, Logging Manager, Administrator, and Heartbeat Monitor. The Protocol Manager converts incoming data request messages to a format understood by the MAS and converts outgoing data messages to formats understood by the various subscriber devices and networks that access the MAS. The Provisioning Manager verifies the subscriber, the device, and the application to insure that the user is authorized to use the requested application, the device can support the requirements of the application, and the application has not been banned by, for example, the carrier from the requested use. In addition, the Provisioning Manager may preprocess or post-process the data request to implement, for example, additional carrier billing policies, or to communicate with other MAS components. The Deployment Manager retrieves a pre-provisioned application if one exists that meets the requests, otherwise retrieves the designated application code and provisions it for the requesting subscriber and device. In one embodiment, provisioning includes application code inspection, optimization, instrumentation, and packaging. The Billing Manager generates billing reports and billing parameter data used to generate such reports. In addition, in some embodiments, the Billing Manager handles the accounting for pre-paid billing policies. The logging manager is responsible for logging all types of request and transmission information, including the status of pending requests. The Heartbeat Monitor tracks the ability of the MAS components to perform their intended work. In one embodiment, a second Heartbeat monitor is provided to track the status of the first Heartbeat Monitor. The Administrator supports the administration of the MAS for content providers, system administrators, customer care representatives, and subscribers. In one embodiment the Administrator implements website based user interfaces for the content provider, administrator, customer care representative, and subscriber. In another embodiment, the Administrator provides the support for profile management of one or more of application profiles, subscriber profiles, device profiles, java profiles, and billing profiles. In yet another embodiment, the Administrator supports the modification of existing MAS components by modifying data that drive the behavior of the MAS components.

In some embodiments, the MAS provides a command interface to the system, which supports application discovery, content downloading, and content downloading history. The MAS also provides the ability to directly invoke one of the MAS components through a handler. In some embodiments, the MAS also provides an API to access each of these components and to integrate with portions of the MAS.

The MAS also provides an ability to reconfigure itself through dynamically modifying mappings of commands and parameters to different aspects of the MAS.

### BRIEF DESCRIPTION OF THE DRAWINGS

FIG. 1 is an example block diagram that illustrates how subscribers of wireless services request and download software applications from a Mobile Application System. FIG. 2 is an example block diagram of a Handset Administration Console that operates with a Mobile Application System.

FIG. 3 is an example overview flow diagram of the general steps performed by an example Mobile Application System to provision applications for wireless subscriber devices.

FIG. 4 is an example overview flow diagram of the steps performed by an example Mobile Application System to perform application discovery for wireless subscriber devices.

FIG. 5 is an overview block diagram of the components of an example embodiment of a Mobile Application System.

FIG. 6 is an example block diagram of the components of an example Provisioning Manager of a Mobile Applications System.

FIG. 7 is an example block diagram of the components of a Deployment Manager of a Mobile Application System.

FIG. 8 is an example block diagram of an Administrator component of a Mobile Application System.

FIG. 9A is an example screen display of an application submission screen of a Content Provider Website.

FIGS. 9B and 9C are an example screen displays of an additional information submission screen of a Content Provider Website.

FIG. 10A is an example screen display of a category maintenance screen of an Administration Website.

FIG. 10B is an example screen display of a pending applications maintenance screen of an Administration Website.

FIGS. 10C-109E are an example screen displays of portions of an edit pending application screen of an Administration Website.

FIGS. 10F-10J are example screen displays of portions of the application filter management interface of an Administration Website.

FIG. 10H shows an example screen display for changing the selected target to be one of a Java profile, a device profile, a content provider, or all available targets.

FIG. 10K is an example screen display of a billing method management interface of an Administration Website.

FIGS. 10M-10P are example screen displays of subscriber maintenance screens within the Administration Website.

FIG. 10Q is an example screen display of a message interface of an Administration Website.

FIG. 10R is an example screen display of a reports screen of an Administration Website.

FIGS. 10S-10T are example screen displays of device maintenance screens within the Administration Website.

FIG. 11A is an initial screen display of the Personalization Website.

FIGS. 11B-11D are example screen displays for managing service plans using a Personalization Website.

FIGS. 11E-11H are example screen displays for adding applications to a subscriber's Personal Access List.

FIG. 11J is an example screen display for removing applications from a subscriber's Personal Access List.

FIGS. 11K-11L are example screen displays for organizing the order of applications on a subscriber's Personal Access List.

FIG. 12 is an example block diagram of a general-purpose computer system and a subscriber device for practicing embodiments of the Mobile Application System.

FIG. 13 is an example flow diagram of processing performed by a Protocol Manager of a Mobile Application System to communicate with various subscriber devices.

FIG. 14 is an example flow diagram of processing performed by a Provisioning Manager of a Mobile Application System to determine the suitability of a requested application.

FIG. 15 is an example flow diagram of processing performed by a Perform Walled-Garden Provisioning routine of a Provisioning Manager.

FIG. 16 is an example flow diagram of processing performed by a Verify Application routine of a Provisioning Manager.

FIG. 17 is an example flow diagram of processing performed by a Verify Subscriber routine of a Provisioning Manager.

FIG. 18 is an example flow diagram of processing performed by a Verify Device routine of a Provisioning Manager.

FIG. 19 is an example flow diagram of processing performed by a Perform Open Provisioning routine of a Provisioning Manager.

FIG. 20 is an example flow diagram of processing performed by a Perform Application Discovery routine of a Provisioning Manager.

FIG. 21 is an example flow diagram of processing performed by a Deployment Manager of a Mobile Application System to provide provisioned applications.

FIG. 22 is an example flow diagram of processing performed by a Procure Provisioned Application routine of a Deployment Manager.

FIG. 23 is an example flow diagram of processing performed by a Provision Application routine of a Deployment Manager.

FIG. 24 is an example flow diagram of processing performed by an Inspect Application routine of a Deployment Manager.

FIG. 25 is an example flow diagram of processing performed by an Optimize Application routine of a Deployment Manager.

FIG. 26 is an example flow diagram of processing performed by an Install Instrumentation routine of a Deployment Manager.

FIG. 27 is an example flow diagram of processing performed by a Package Application routine of a Deployment Manager.

FIG. 28 is an example flow diagram of processing performed by a Billing Manager of a Mobile Application System.

### DETAILED DESCRIPTION OF THE INVENTION

Embodiments of the present invention provide computer- and networkbased methods and systems for maintaining and provisioning wireless applications. Provisioning, as it is discussed herein, is the customizing and distributing of content for a particular use, for example, for use on a particular kind of subscriber device by a particular customer. In an example embodiment, a Mobile Application System (MAS) is provided. The MAS is a collection of interoperating server components that work individually and together in a secure fashion to provide applications, resources, and other content to mobile subscriber devices. The MAS allows, for example, wireless devices, such as cellular phones and handset devices, to dynamically download new and updated applications from the MAS for use on their devices. Dynamic download capability significantly reduces time-to-market requirements for developers of wireless applications (content providers) and results in greater efficiencies in product support and marketing. Customers are able to quickly and conveniently update the operating software on their wireless devices and download popular applications (including games). With the MAS, customers are able to update their wireless handset devices directly from the network and thereby avoid the time-consuming experience of speaking to a customer service representative or visiting a local service center to update the software. The MAS also supports flexible billing scenarios, including subscription billing, which allows customers to subscribe to a particular service to receive only those resources or applications they desire.

Although the capabilities of the MAS are generally applicable to any type of client wireless device, one skilled in the art will recognize that terms such as subscriber device, client device, phone, handheld, etc., are used interchangeably to indicate any type of subscriber device that is capable of operating with the MAS. In addition, example embodiments described herein provide applications, tools, data structures and other support to implement maintaining and distributing wireless applications over one or more networks. One skilled in the art will recognize that other embodiments of the methods and systems of the present invention may be used for many other purposes, including maintaining and distributing software and other content over non-wireless networks, such as the Internet, to non-wireless subscriber devices, such as a personal computer, a docked wireless handset, telephones with Internet connectivity, or customer kiosks, for example, within airports or shopping malls. In addition, although this description primarily refers to content in the form of applications and resources, one skilled in the art will recognize that the content may contain text, graphics, audio, and video. Also, in the following description, numerous specific details are set forth, such as data formats, user interface screen displays, code flows, menu options, etc., in order to provide a thorough understanding of the techniques of the methods and systems of the present invention. One skilled in the art will recognize, however, that the present invention also can be practiced without some of the specific details described herein, or with other specific details, such as changes with respect to the ordering of the code flow, or the specific features shown on the user interface screen displays.

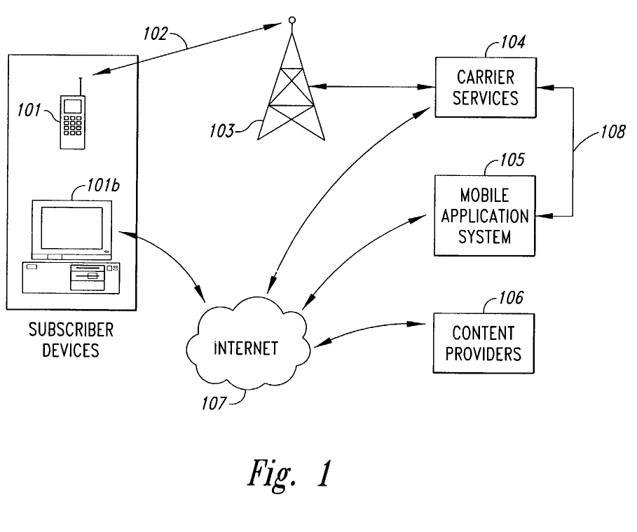

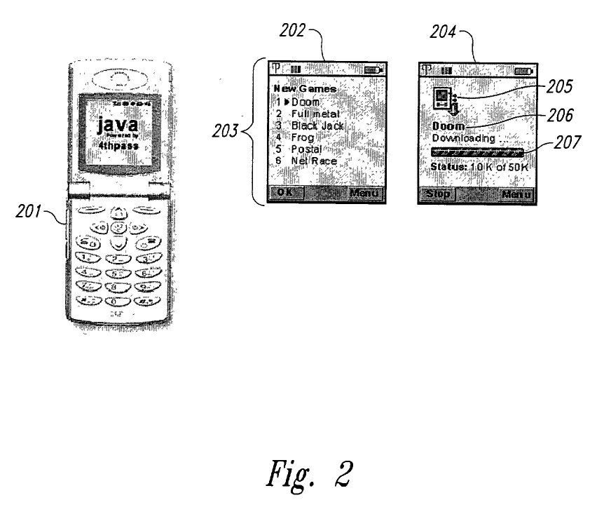

FIG. 1 is an example block diagram that illustrates how subscribers of wireless services request and download software applications from a Mobile Application System. The wireless environment in which the MAS operates includes subscriber devices 101 and 101b, wireless network 102 with transceiver 103, wireless carrier services 104, the MAS 105, and various content providers 106. Content providers 106 provide applications to the MAS 105, through or by permission of the carrier services 104. The applications are then verified, published, and provisioned to the subscriber devices 101 by the MAS 105 when requested. This type of provisioning is referred to herein as “walled-garden” provisioning, because applications that are provisioned and published in this fashion are known to the carrier and/or MAS infrastructure. Content providers 106 can also host applications that can be browsed by subscriber devices, which can be provisioned dynamically by the MAS 105. This type of provisioning is referred to herein as “open” provisioning, because it is not restricted to applications “known” within the confines of the MAS or carrier infrastructure. These distinctions are made for convenience of discussion alone, as the different types of provisioning share many similar functions. The MAS 105 also provides a multitude of tools for carriers, content providers, customer care representatives, and subscribers for customizing the applications, services, and billing scenarios available to specific subscribers or groups of subscribers.

In FIG. 1, the subscriber devices 101 comprise electronic devices capable of communication over wireless network 102, such as wireless handsets, phones, electronic organizers, personal digital assistants, portable e-mail machines, game machines, pages, navigation devices, etc., whether or not existing presently. One or more of the subscriber devices 101 (also referred to as client devices) communicate across the wireless network 102 to the wireless carrier services 104, whose services the subscriber has arranged to use. The wireless network 102 has a transceiver 103, which is used to relay services to the subscriber devices 101 (and handle subscriber requests). One skilled in the art will recognize that a subscriber of wireless services may complement any or all of steps involved in requesting and downloading wireless applications across a wireless network by using an alternate network (such as the Internet) and by using devices having a larger form-factor, such as a personal computer 101b, which may offer easier-to-use interfaces for downloading applications. The transceiver 103 typically converts wireless communications to cable-based communications, and converts the cable-based communications to wireless communications, although one skilled in the art will appreciate that varying media and protocols may be used. Transceiver 103 typically communicates with the carrier services 104 across a cable-based medium using a carrier-specific communication protocol. The carrier-specific communication may use any protocol suitable for point-to-point communications such as Hypertext Transport Protocol (HTTP) and Wireless Application Protocol (WAP). The carrier services 104 provide services that are typical of a telephone central office including accounting, POTS (“plain old telephone service”) and other telephone services (such as call forwarding, caller ID, voice mail, etc.), and downloadable applications. The Mobile Application System 105 communicates with the carrier services 104, for example, across a high bandwidth communications channel 108 or a publicly accessible network, such as the Internet 107, to provide provisioned applications to the subscriber devices 101. One skilled in the art will recognize that the Mobile Application System 105 may be fully or partially integrated with the carrier services 104. Using walled-garden provisioning, downloadable applications, which are typically generated by the content providers 106, are supplied to the Mobile Application System 105 or to the carrier services 104 directly or across a network, such as the Internet 107. These downloadable applications are then verified and customized as appropriate by the Mobile Application System 105 and provisioned for a subscriber device 101. In an embodiment that supports open provisioning, a subscriber of the carrier may download an application from a website by specifying a location (such as a network address, or URL—Uniform Resource Locator). The MAS intercepts the download request from the subscriber and then locates, verifies, and provisions the application for the customer.

The subscriber device 101 relies on a client-side application management utility (e.g., a Handset Administration Console or a browser) to request and download applications. FIG. 2 is an example block diagram of a Handset Administration Console that operates with a Mobile Application System. The Handset Administration Console handles notification, installation, and uninstallation of applications on the subscriber's wireless device. The subscriber device 201 provides the subscriber with a menu of functionality available for the device. The subscriber may select from the menu routines that, for example, manage applications already installed on the device and present new applications that can be downloaded. For example, the routines may allow the subscriber to obtain version information for installed applications, to download updates for those applications when they become available, and to browse for new applications to be downloaded. Menu 202 is an example menu showing a list of new applications 203 that can be potentially downloaded to the subscriber device 201. Example screen display 204 shows an example user interface that is presented after the subscriber has selected an application for downloading. Screen display 204 presents an icon 205 that depicts the downloading operation, the title of the application being downloaded 206, and a status bar 207 that displays the ongoing process of the download. The screen 204 also presents a stop button 208, which allows the downloading process to be canceled.

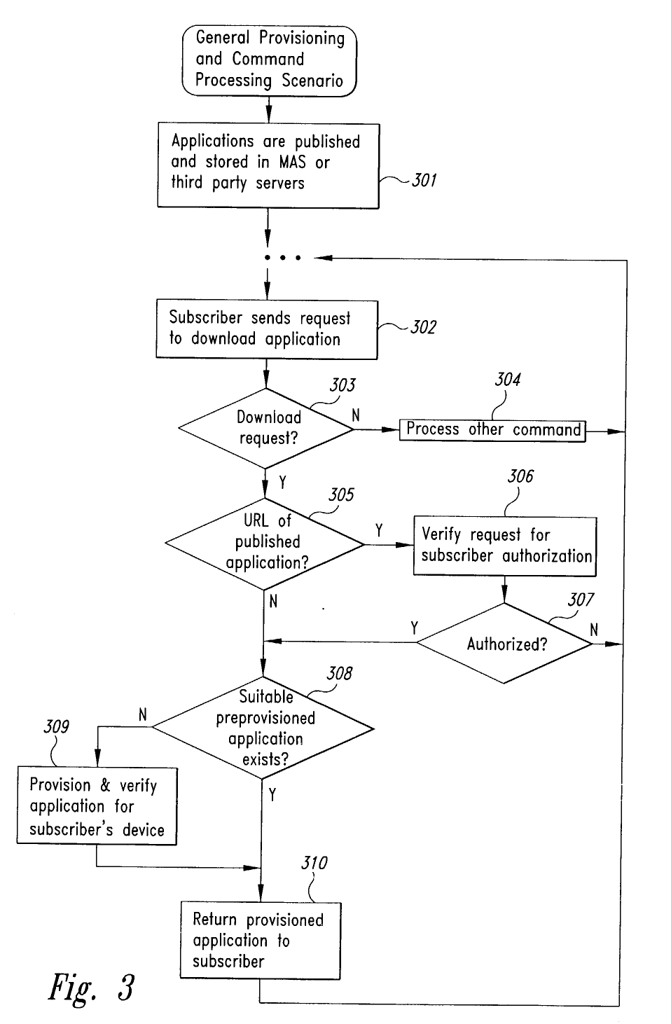

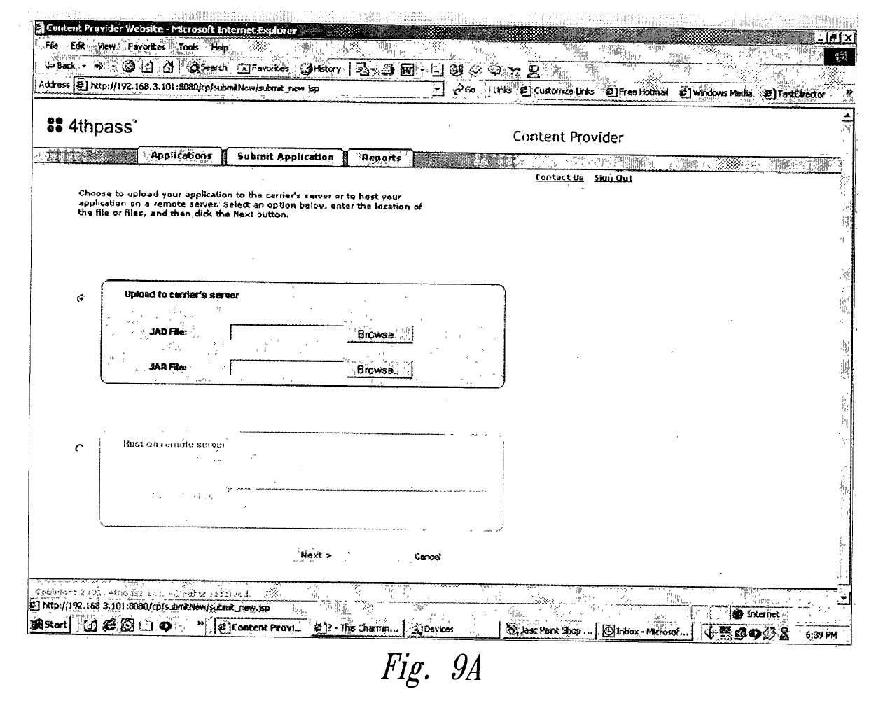

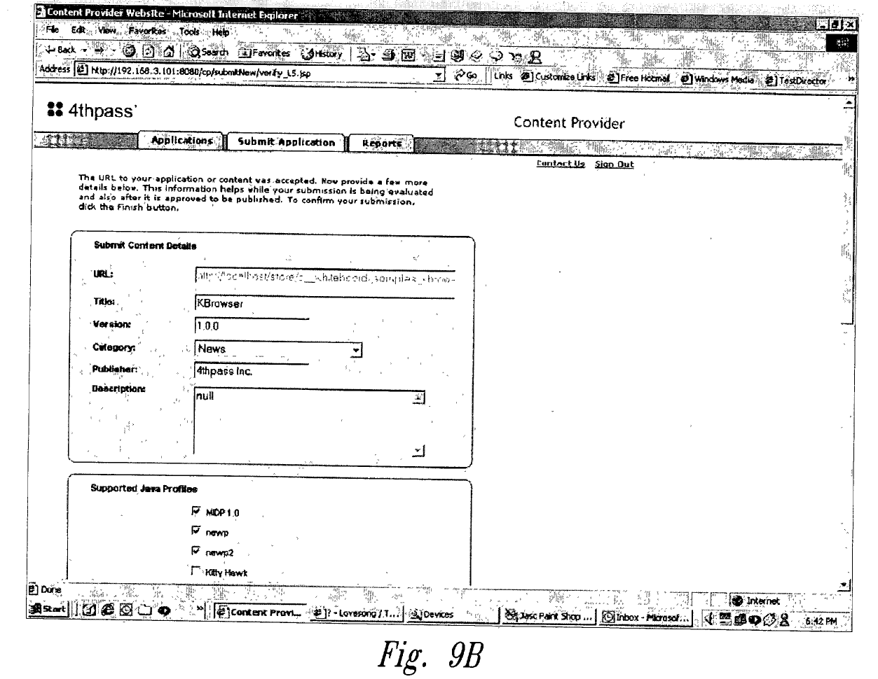

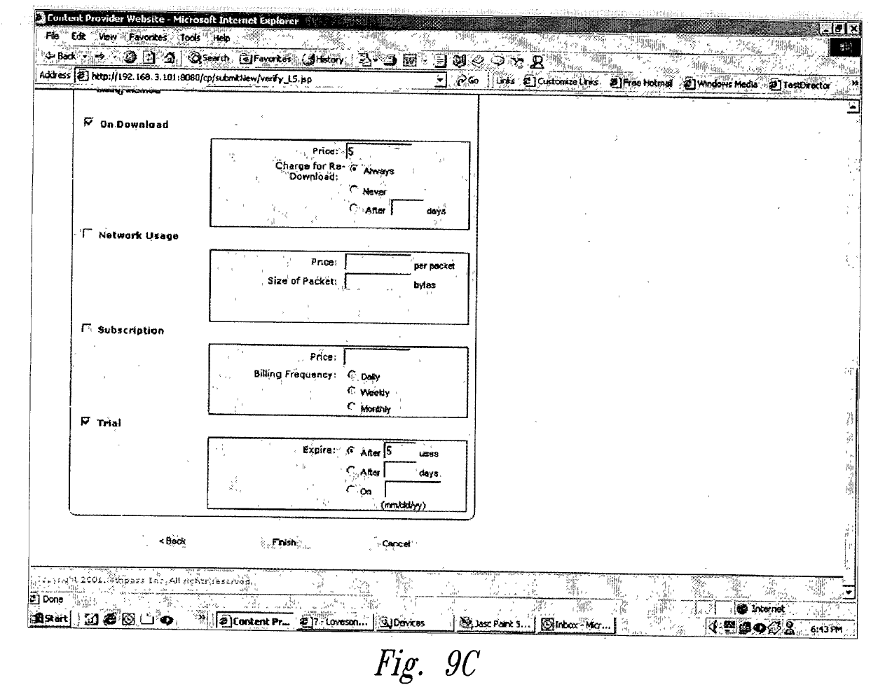

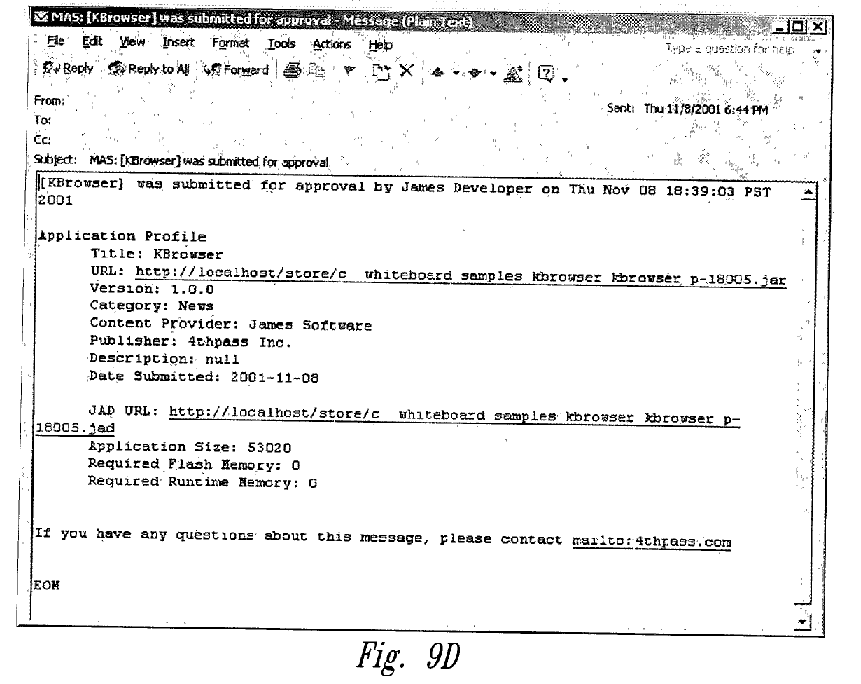

FIG. 3 is an example overview flow diagram of the general steps performed by an example Mobile Application System to provision applications for wireless subscriber devices. These steps are applicable to either provisioning scenario—using walled-garden or open provisioning. These same steps can also be used to provision applications for wired devices, such as those connected through the Internet 107 in FIG. 1. Steps 301-408 demonstrate how the MAS handles an incoming request to download an application from a subscriber device, provisions the requested application, and sends the requested application to the subscriber device. Provisioning includes one or more of the steps of retrieving, inspecting, optimizing, instrumenting code, and packaging, and may include additional steps as needed to ready an application for downloading to a target device. For example, as additional security and billing methods are added to the system, provisioning may include steps for encrypting and reported information. Where distinct, steps 301-408 assume that an application is being requested directly from the MAS as opposed to indirectly by browsing a location on a network. (In the case of open provisioning, the MAS intercepts the request and attempts to provision and download the application as though receiving it for the first time.) Specifically, in step 301, applications are made available for downloading, typically from a carrier or directly from a content provider. Applications may be written using a computer language, such as Java, which is capable of executing on a wide variety of subscriber devices. The applications are stored locally in a carrier's application data repository (which may be located in the MAS or at the carrier's premises) or are optionally stored in trusted third-party servers. (In the case of open provisioning, the third-party servers are not necessarily trusted.) A procedure for submitting applications to the MAS is described further with reference to FIGS. 9A-9C. In step 302, the subscriber sends a request to download an application, retrieve a list of available applications, perform some administrative query, or other command. Protocol conversions are performed on incoming requests (and outgoing messages) to enable communications with subscriber devices across a wide variety of wireless carriers. The downloaded application may be, for example, a new and popular application or an upgrade or a more recent version of software that will run on the subscriber device. Requests are made, for example, using Uniform Resource Locators (URLs) that use the HTTP messaging to direct the requests. The MAS supports an extensible command processing engine and supports the direct invocation of the various handlers, modules, and other structures that are components of the MAS, either through HTTP requests or through an application programming interface (an “API”). In the case of an application provisioning request, the request to download a particular file is made by designating a URL that identifies a file (an application or service) to download. In the case of an administrative query, a request is made to, for example, an administrative servlet or other code in the MAS, which handles the request. In step 303, the MAS determines whether the request is for downloading or for some other command, and, if so, continues in step 305, else processes the command in step 304. In step 305, the MAS determines whether the designated URL specifies a published application (thereby indicating that walled-garden provisioning is to be performed), and, if so, continues in step 306, else continues in step 308. In step 306, the subscriber's request is verified for authorization, device capability, and if appropriate, pre-paid billing authorization. The authorization level will typically depend on the level of service to which the client has subscribed. For example, in one embodiment the MAS supports pre-paid billing, which allows a subscriber to pay ahead for use of applications. In this case, the MAS will verify that the pre-paid billing account can cover the request before the application is downloaded. Other factors may apply such as whether a promotional offer is being tendered, the number of times the subscriber has accessed the service, whether an introductory offer exists, the time of day or week that the service is being accessed, the number of bytes to be downloaded, and other such factors. The device capability is also examined to determine whether the requested application can be run satisfactorily on the subscriber device. This can be performed, for example, by comparing the requesting device to known device profiles and an application profile for the requested application. In step 307, the MAS determines whether the subscriber's request has been successfully verified and, if so, continues in step 308, else it declines the request and returns to step 302 to await another request.

In step 308, the MAS determines if a pre-provisioned application already exists that corresponds to the subscriber request and is suitable for the subscriber device. A pre-provisioned application is an application that has been pre-customized according to the level of authorization and the capability of the subscriber device. Pre-provisioned applications, when available, minimize system latency and enhance system response time for a corresponding application request. Applications may be pre-provisioned according to typical levels of subscription of subscribers and typical subscriber devices (as determined, for example, by projected use) and stored for later access to respond to a subscriber device request for an application that corresponds to a pre-provisioned application. If the application has not been pre-provisioned, the MAS provisions the application dynamically, which will increase the time required to process the request, but will produce a customized and authorized application for deployment.

In step 308, if a suitable pre-provisioned application has been found for the subscriber device, the provisioning scenario continues in step 310, else it continues in step 309. In 309, the application is provisioned for the specific subscriber device and according to access authorization. In step 310, the MAS sends off the provisioned application to the subscriber device for downloading.

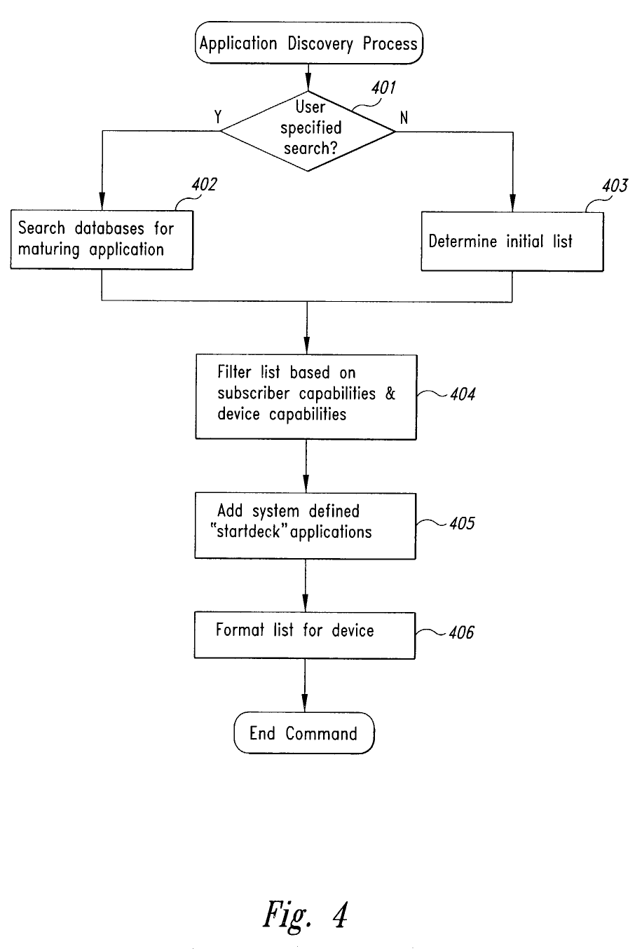

As mentioned, one of the requests supported by the MAS is to retrieve a list of available applications that can be downloaded to the subscriber's device. This process is referred to as application discovery. FIG. 4 is an example overview flow diagram of the steps performed by an example Mobile Application System to perform application discovery for wireless subscriber devices. In an example embodiment, two types of application discovery are supported. The first is driven by the system and generates a system-derived list. The second is driven by the requester and specifies search terms that are matched by the MAS to generate a list of “suitable” applications. In step 401, the MAS determines whether the user has supplied any search terms, and, if so, continues in step 402, else continues in step 403. In step 402, the MAS searches a data repository of published applications for those that meet criteria specified in the request, and continues in step 404. Alternatively, in step 403, the MAS determines an initial list. In one embodiment this list is formed from a subscriber's personalized list if one is available, otherwise the MAS supplies a default list. In step 404, the MAS filters this initial list based upon subscriber and device capabilities. For example, the MAS may analyze various profiles, for example a subscriber profile, a device profile, and an application profile to determine whether the subscriber is authorized to use the application and whether the application's needs, as reflected in the application profile, are met by the device, as reflected in the device profile. In step 405, the MAS adds any system defined applications to the list (referred to as the “startdeck”). Such applications may be designated according to customizable rules of the carrier, for example, applications that generate more revenue may be given “premium” viewing time by placing them at the top of the list. In step 405, the MAS formats the list according to the viewing capabilities of the requesting device (for example, the markup language supported), and ends processing.

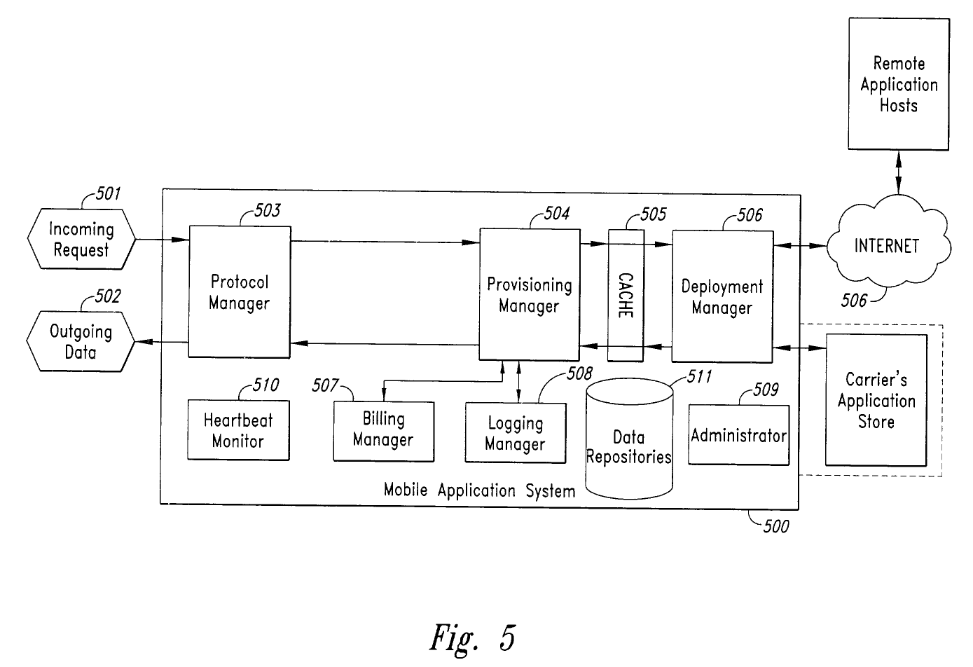

FIG. 5 is an overview block diagram of the components of an example embodiment of a Mobile Application System. In this embodiment, the Mobile Application System 500includes a Protocol Manager 503, Provisioning Manager 504, Cache 505, Deployment Manager 506, Billing Manager 507, Logging Manager 508, Administrator 509, and Heartbeat Monitor 310. These components inter-operate to receive applications from content providers and carrier services, to provision them for delivery to the subscriber devices, such as those shown in FIG. 1, and to process MAS commands. One skilled in the art will recognize that many different arrangements and divisions of functionality of the components or different components of the MAS are possible. For example, the functions allocated to the Protocol Manager 504 and the Billing Manager 507 could be combined in one component. Other arrangements are also possible and contemplated.

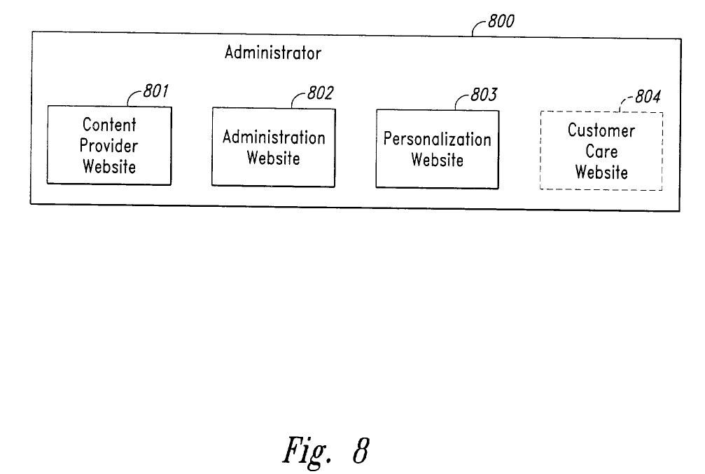

The various components of the MAS inter-operate to provide a multitude of capabilities to carrier (or system) administrators or customer care representatives who administer the services provided by the carrier, content providers who develop and distribute applications and services to the carriers, and subscribers who consume the services, applications, and other content. The Administrator 509 provides various user interfaces to each of these types of users to configure the MAS, applications, billing and other services, and to customize a subscriber's experience with the MAS. Examples of these interfaces are shown below and described with reference to FIGS. 8-11. To illustrate the provisioning aspects, the functionality of the MAS is described from the point of view of the processing steps that occur in the MAS components when a subscriber invokes the MAS to download applications to the subscriber's device, as described with reference to FIG. 3. One skilled in the art will recognize that other data flows and usages of the components are appropriate and depend upon the commands processed and/or how the components, or code within them, are invoked.

More specifically, in the example embodiment shown in FIG. 5, communications from subscriber devices, such as J2ME or WAP handsets, are presented to and received from the Mobile Application System 500 as Incoming Request 501 and as Outgoing Data 502, respectively. Typically, the MAS is invoked by a subscriber via the command interface (as opposed to the website based interfaced) to process two different types of input requests: discovery of applications and downloading of a requested application. The MAS may also be invoked to process other commands. Also, components of the MAS, for, may be invoked directly, , such as to perform administrative requests to obtain usage information. When input request 501 is a request for application discovery, the MAS compiles and returns a list of applications that are available and appropriate based on the subscriber, application profiles, and device profiles. The steps typically executed by the MAS to accomplish application discovery are described with reference to FIG. 4. Alternatively, when input request 501 is a request to download a designated application, the MAS retrieves the application, verifies that it is appropriate and permitted for download to that device and user, provisions and packages the requested application, and sends the packaged application to the requesting subscriber device. The steps typically executed by the MAS to accomplish provisioning applications were described with reference to FIG. 3.

The Protocol Manager 503 performs protocol conversion of the messages between the subscriber devices and the Provisioning Manager 504. Protocol conversion ensures that the MAS 500 can communicate with any subscriber device (wired or wireless), independent of the communication protocol used in the network (such as wireless network 102 in FIG. 1), and allows incoming requests that may be embedded within various protocols to be processed. An example Protocol Manager 503 has built-in support for WAP and HTTP protocols and can be extended using well-known techniques to provide support for additional formats and protocols. One or more separate gateways such as a WAP gateway (not shown), may reside between the Protocol Manager 503, the incoming request 501/outgoing data 502. These gateways may be used to process messages targeted for a particular protocol. The Protocol Manager 503 may also optionally include a plug-in security layer to handle data encryption and decryption as well as certificate management for end-to-end security support. One skilled in the art will recognize that the Protocol Manager 503 can be extended to include other types of support for secure communications as desired.

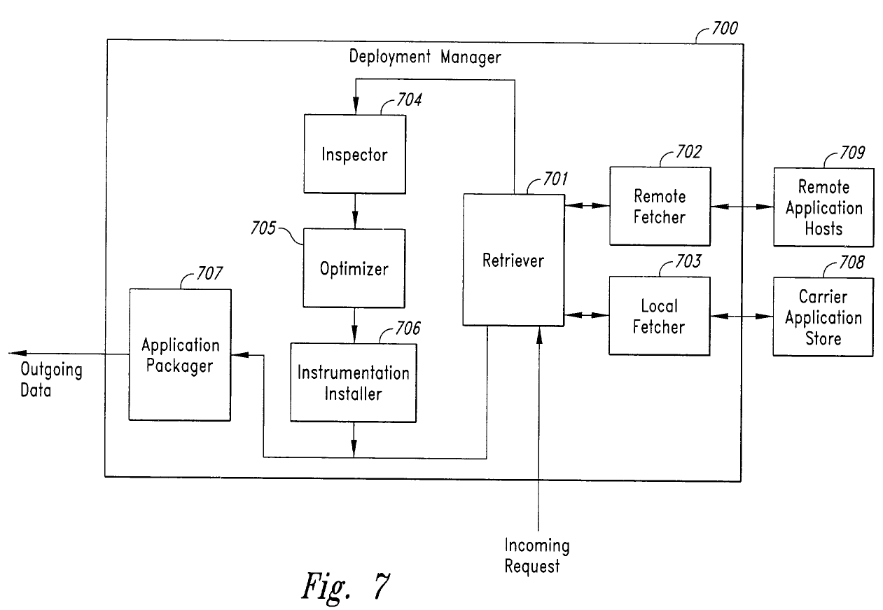

After the incoming request is appropriately converted, the Provisioning Manager 504 processes the request, engaging the assistance of other components as needed. For example, if the request is an administrative query, then the Provisioning Manager 504 may forward the request to an administrative servlet in the MAS. If, instead, the request is for a list of applications that can be downloaded to a subscriber's device, then the Provisioning Manager 504 may interrogate the Data Repositories 311 and profile management code to generate such a list by comparing the capabilities and requirements of each application available from the carrier with the appropriate device and subscriber profiles that correspond to the subscriber's device and the subscriber. If, on the other hand, the request is from a subscriber to download a designated application, then the Provisioning Manager 504 and Deployment Manager 506 interact to obtain and ready the requested application for distribution to the subscriber. In one embodiment, the Provisioning Manager 504 verifies the user, device, billing, and application information referred to by a subscriber request and the Deployment Manger 506 retrieves and provisions the applications. The application provisioning process performed by the Deployment Manager 506 comprises one or more of the following processing steps: retrieving, inspecting, optimizing, instrumenting code, and packaging, which are discussed below with reference to FIG. 7.

The Provisioning Manager 504 receives subscriber requests from the Protocol Manager 503 and handles download requests or other commands that are contained in the subscriber requests. The download requests are handled based on information submitted with each download request and other information that is accessible by the MAS (for example, profiles store in data repository 511). When processing a request to download an application, the Provisioning Manager 504 examines previously created or available profiles for the subscriber, the subscriber devices, and the requested application(s) and information related to billing to determine the suitability of the requested application for the subscriber using the particular subscriber device and according to the subscriber's billing method. After inspecting the profiles, the Provisioning Manager 504 either approves or denies the request by attempting to evaluate, for example, whether the requested application can be successfully run on the subscriber device. This evaluation is performed, for example, by determining whether the requirements of the application can be met by the capabilities of the particular subscriber device. The Provisioning Manager 504 also determines whether the billing method that has been set up for the requested application and the subscriber is compatible and sufficient to perform the download. For example, if the request indicates that the subscriber is part of a pre-paid billing program, then the Provisioning Manager 504 verifies that the subscriber's pre-paid billing account funds are sufficient to allow the application download.

Once approved, the Provisioning Manager 504 may obtain the requested application from either the cache 505 or from the Deployment Manager 506. Typically, the cache 505 is used to store frequently downloaded applications in a pre-provisioned format, while the Deployment Manager 506 is used to provision applications dynamically, as they are requested. Applications that are controlled by the carrier are typically pre-provisioned and stored in the cache 505, while applications available through, for example, an Internet site, are typically provisioned only when requested for download.

The cache 505 is used to provide faster delivery of the requested application to the subscriber device. The cache 505 is used to cache provisioned applications that have been processed ahead of time for specific profiles such as for specific subscriber devices or according to authorized access. Applications stored in the cache 505 that have already been inspected, optimized, and instrumented are tagged as being ready for deployment. One skilled in the art will recognize that system performance may be enhanced by implementing similar caching functionality between other components of the MAS as well. For example, a cache to hold Internet applications, which resides between the Deployment Manager and the Internet, could reduce the access time required for communicating with Internet applications. Also, for example, a cache to hold unarchived JAR files could be implemented to speed up the instrumentation process. Other configurations are also possible. If an approved requested application for a particular subscriber and particular device is not found in the cache 505, it can be retrieved via the Deployment Manager 506. The Deployment Manager 506 prepares applications for delivery to a subscriber device. The Deployment Manager 506 manages many facets of preparing, maintaining, and provisioning applications, such as malicious application detection, restricted API usage, support for trial distribution (use allowed for only a set number of times or a set period of time) and other billing methods, application size optimization for the requesting subscriber devices, and other facets. The Deployment Manager 506 obtains applications and provisions each application instance for its intended (requested) use when an instance of an application is requested. It may also pre-deploy (“pre-provision”) applications for specific device and/or subscriber profiles by preparing applications for those profiles in advance and storing the results for quick access in the cache 505, or other data repository. As is discussed below with reference to FIG. 7, the Deployment Manager 506 may deploy applications from a carrier's application data repository or from remote application hosts (trusted or otherwise), or from any other application source. After the Deployment Manager 506 has suitably provisioned the requested application, it sends the requested application back to the Provisioning Manager 504 for any postprocessing to the outbound response.

As a provisioned application is being delivered to a user, the details about the transaction typically are recorded in the Logging Manager 508, which is accessible to the Billing Manager 507 to enable a variety of billing methods. The recorded data includes information pertaining to the incoming request 501 and the deployed application such as the subscriber ID, the size of the download, the time and date of the download, the particular application downloaded, etc. Because of the wide range of information recorded about the download, the carrier has great flexibility in methods of billing for the provisioning of applications according to different categories of service and subscribers. The carriers can bill, for example, by the amount of airtime used, the time of download, the amount of data downloaded, the demographics of the client, or on the basis of the particular application that was downloaded.

The Billing Manager 507 is responsible for assisting in the enforcement of billing methods. In an example embodiment, several initial billing options are provided: (1) download charges based upon downloading an application; (2) packet-based billing charges based upon transmissions of network packets; (3) subscription charges based upon periodic fees such as daily, weekly, or monthly; (4) trial use charges based upon any metric of trial use, for example the number of times an application can be executed; and (5) pre-paid billing. These billing options are customizable at both the carrier level and the application level, and, when more than one is offered for a particular application, a desired billing option may be selected by a subscriber. In an example Mobile Application System 500, an application programming interface (API) is provided for easy integration with a carrier's existing billing subsystem. If a carrier supports pre-paid billing, a subscriber can establish an account that is maintained by the carrier. In one embodiment, the subscriber prepays for applications to be downloaded at a later time. When the subscriber downloads a pre-paid application, the Billing Manager 507 forwards a billing record to the pre-paid billing system of the carrier so that the subscriber's account can be charged and updated. In an alternate embodiment, pre-paid subscriber accounts are stored and maintained by the Billing Manager 507. Other configurations are also possible, as well as support for other types of billing methods. After the Billing Manager 507 has generated billing related information, the application is forwarded to the Protocol Manager 503, where it is then reformatted for a different protocol if required and transmitted to the customer as outgoing data 502.

The Administrator 509, discussed below with reference to FIGS. 8-11, interacts with the other components of the example MAS 500 to customize various aspects of the MAS 500. For example, the Administrator 509 allows carriers to implement customizable provisioning-related policies and integrate the MAS with their own infrastructures through reprogramming components of the Mobile Application System itself, thereby allowing subscribers, carriers, system administrators, and content providers enhanced flexibility in performing profile management, report generation, billing method administration and server administration.

The Heartbeat Monitor 510 monitors and provides reports on other MAS 500 components and provides appropriate notifications when relevant system events occur, for example, to detect problems in the system such as a component becoming inoperative. For example, the Heartbeat Monitor 510 can monitor the Protocol Manager 503 to determine if the Protocol Manager 503 responds to an incoming request within a predetermined time limit. If the Heartbeat Monitor determines that the Protocol Manager 503 is not properly responding, it can flag the event and notify a system administrator. In one embodiment, multiple Heartbeat Monitors 510 are provided so that a second monitor can monitor whether the first monitor is functioning properly and take over if necessary. The Heartbeat Monitor 510 is capable of both active monitoring (by polling devices with status requests) and passive listening (by verifying that specific types of communications occur at appropriate times). The Heartbeat Monitor 510 also provides interfaces to industry standard protocols, for example Simple Network Management Protocol (SNMP), to enable other external code to monitor the MAS.

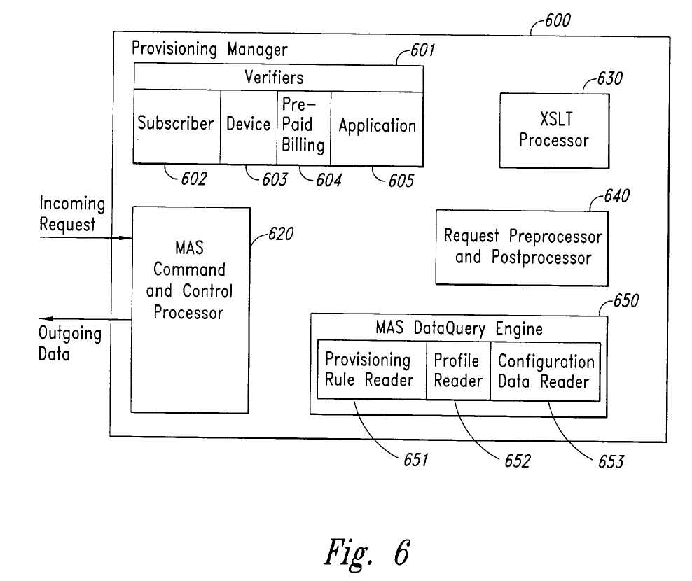

As described with reference to FIG. 5, the Provisioning Manager of the MAS processing the incoming download requests and other commands, and drives dynamic provisioning of applications for downloading. FIG. 6 is an example block diagram of the components of an example Provisioning Manager of a Mobile Applications System. In one embodiment, the Provisioning Manager 600 comprises a MAS Command and Control Processor 620 (the “MCCP”), Verifiers 601, XSLT processor 630, Request Preprocessor and Postprocessor 640, and MAS Data Query Engine 650. The MCCP is responsible for decoding the request and directing it to the correct MAS subcomponent, for example, to download a published application or to perform application discovery. The Verifiers 601, which comprise Subscriber Verifier 602, Device Verifier 603, Pre-Paid Billing Verifier 604, and Application Verifier 605, perform verifications to determine suitably of an application for a subscriber and a device. The XSLT processor (which can be implemented, for example, as an industry standard Extended Stylesheet Processor) is used to format the data according to the rendering capabilities of the requesting device. In one embodiment, it supports stylesheets for XML, but can easily be extended to provide additional stylesheets for HTML, Java, WML, XHTML Basic, and text, or any other markup or rendering language. The Request Preprocessor and Postprocessor 640 manipulates parameters in the request “packets” to communicate amongst the other components, and can be extended to perform any type of processing that can be “hooked” in at this level. The MAS Data Query Engine 650 manages communication with the various data repositories. It includes readers for Provisioning 651, Profiles 652, and Configuration Data 653. Although no arrows are shown connecting these components for ease of viewing, one skilled in the art will recognize that the components are interconnected and inter-operate in many ways.

Initially, the Provisioning Manager 600 receives an incoming request such as from the Protocol Manager(for example, Protocol Manager 504 of FIG. 5). The Provisioning Manager 600 optionally preprocesses the request by analyzing the incoming request and modifying the request dynamically to allow for enhancing, altering, or limiting the provisioning, billing, or logging steps to be taken later. Such dynamic modification enables carriers to hook their own infrastructure dynamically into the system. For example, the Provisioning Manager 600 can look at the request headers passed along with the incoming download request and modify, add, or remove the headers to modify the behavior of the system. Because other components in the MAS use information contained with the headers to perform their functions, updating or modifying the header information provides a means to extend or limit the functionality of a specific request, or modify the behavior of the MAS.

The request, when received from the MAS command interface (as opposed to directly invoked via website or API) is processed by the MCCP. If the request is for application discovery or to download content, various Verifiers 601 are used to determine compatibility of an application. If the request is for some other command, then it is processed accordingly.

The Application Verifier 604 determines whether a requested application has been forbidden by the carrier for deployment. Specifically, the Application Verifier 604 examines a list of applications that the carrier does not want to allow to be downloaded to determine if the carrier has banned the requested application. This situation could occur, for example, if an application has been suddenly found to provide malicious behavior and the carrier wants to immediately halt its distribution.

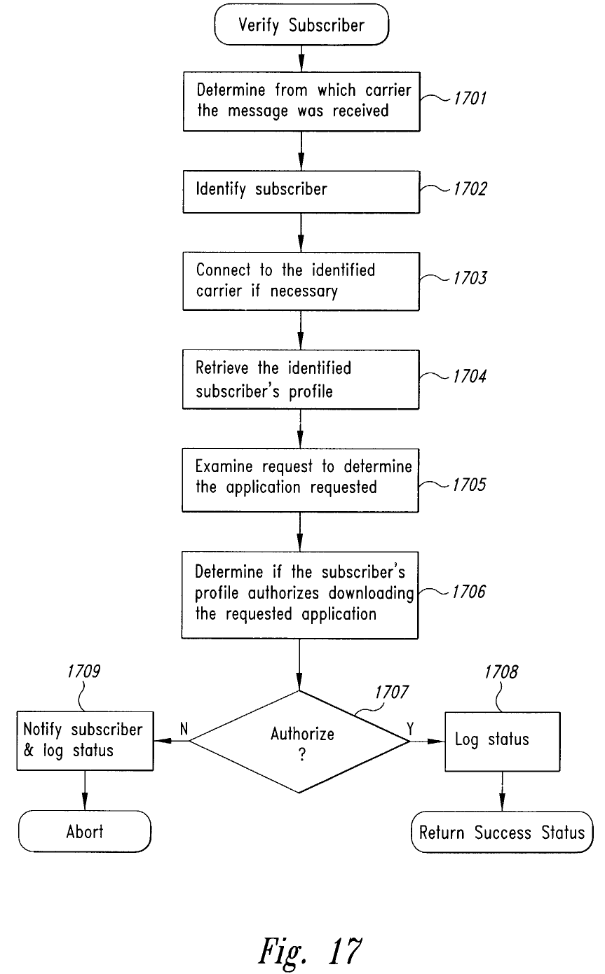

The Subscriber Verifier 601determines the identity of the subscriber from whom the request originated and determines the level of services to which the subscriber is entitled to determine whether the subscriber is authorized to use a specific application. The particular services to which the subscriber is entitled may be determined by retrieving, using the Profile Reader 652, a corresponding subscriber profile and examining a variety of factors, either singly or in combination. Factors may, for example, include the number of downloads permitted within any month, the time required for downloads, the time of day and time of week in which the request is made, the availability of special offers and grace periods, etc. The Subscriber Verifier 601 also can determine a subscriber group to which a subscriber belongs and determine the level of access permitted to the subscriber by determining the services that are allowed and not allowed for the subscriber group as a whole. An example embodiment of the determination performed by the Subscriber Verifier is described with reference to FIG. 17.

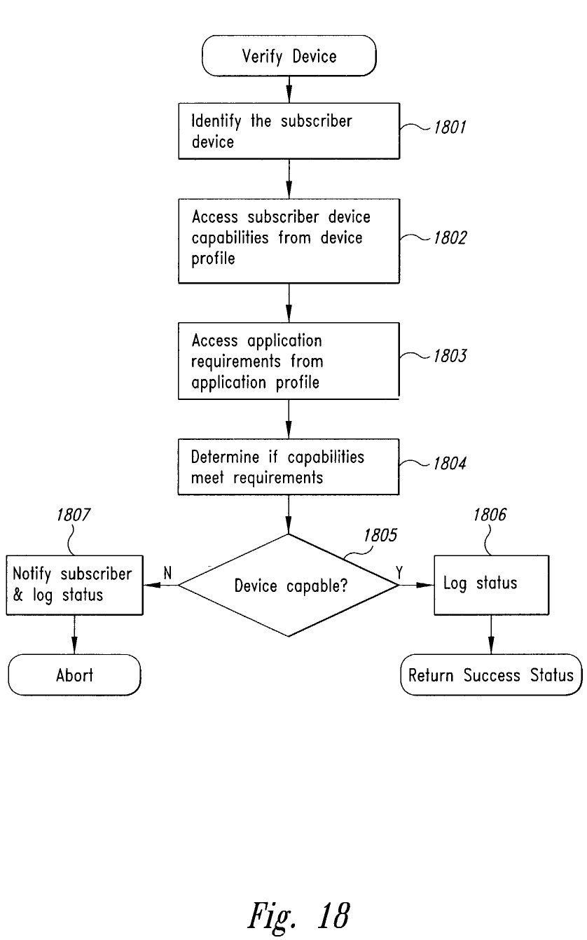

The Device Verifier 602 determines the type and capabilities of the subscriber device from which the request was made and determines whether the device capabilities are sufficient to support a specific application. The capabilities of the subscriber device are determined by retrieving using the Profile Reader 652 a device profile, if one exists, that corresponds to the requesting subscriber device. The device profile is examined to determine whether the device has the characteristics required by the requested application to execute properly on the subscriber device. An example embodiment of the determination performed by the Device Verifier 502 is described with reference to FIG. 18.

When a pre-paid billing method is supported by the MAS, the Pre-Paid Billing Verifier 603 queries the carrier pre-paid billing infrastructure, whereever billing records for individual subscribers are stored. A download request is allowed to proceed to provisioning, typically only if there are sufficient funds in the subscriber's account, as indicated by the carrier.

After the Provisioning Manager 600 has determined that the subscriber device is suitable to run the requested application, the subscriber is authorized to use the application and has sufficient funds (if part of a pre-paid billing scheme), then the Provisioning Manager 600 invokes a provisioning interface of the Deployment Manager to obtain a corresponding provisioned application. The Deployment Manager, which is described with reference to FIG. 7, retrieves and provisions the requested application and returns it to the Provisioning Manager 600.

After a provisioned application suitable for downloading to the subscriber device is obtained from the Deployment Manager, the Provisioning Manager 600 optionally postprocesses the request. As with preprocessing, postprocessing may perform additional modifications to the verified request so that the modifications can be used to extend the functionality of the MAS. For example, instructions can be associated with the request that will later direct the Protocol Manager (for example, Protocol Manager 503 of FIG. 5) to package the request for a custom protocol.

As mentioned, the Deployment Manager (such as Deployment Manager 506 of FIG. 5) receives a subscriber request from the Provisioning Manager or receives a direct request (such as from a system administrator) to obtain a provisioned application that corresponds to the request. The request includes a URL of the requested application, which indicates a source location for the application. In one embodiment, the URL references a list of mirror sites and retrieves the application from an optimal location that is determined from the MAS. In another embodiment, the URL is a proxy and the Deployment Manager redirects the URL to its actual location. Such methods can provide additional security layers to the system. One skilled in the art will recognize that any method of indicating a location for the application can be used with these techniques, and that these techniques operate on indicators other than URLs. The application is also inspected, optimized, and instrumented for delivery before it is deployed and sent to the subscriber.

FIG. 7 is an example block diagram of the components of a Deployment Manager of a Mobile Application System. The Deployment Manager 700 comprises a Retriever 701, Remote Fetcher 702, Local Fetcher 703, Inspector 704, Optimizer 705, Instrumentation Installer 706, and Application Packager 707. The Retriever 701 is obtains the application code from the proper host server using either the Remote Fetcher 702 or the Local Fetcher 703 and then passes the application code through a variety of components to properly provision the application code. In particular, the Inspector Component 704 inspects the application for malicious code and forbidden API; the Optimizer Component 705 reduces the size of the code if possible; and the Instrumentation Installer 706 incorporates carrier specified policies and administrative features, for example billing and notification messages, into the code.

Specifically, the Retriever 701 is designed to allow multiple users and multiple carriers to communicate over a variety of networks using different protocols. This is accomplished, in part, by allowing carriers flexibility in the locations of the software applications (content) that they host for distribution. For example, carriers may choose to host all available applications from their own network by storing such applications in designated directories on an FTP or HTTP server or data repository, such as a standard DBMS. The Carrier Application Store 708 is such a data repository, and may reside on a server of the MAS itself. The Retriever 701 activates Local Fetcher 703 to retrieve a copy of the locally stored data. Carriers may also choose to allow trusted third-party application providers to host the applications from Remote Application Hosts 709, which are under the control of the trusted third-party application providers. In addition, when used to perform open provisioning, the Retriever 701 can retrieve applications from third party hosts that are not necessarily from trusted sources. In both cases, the carrier uses a URL supplied by the third party to refer the incoming request to a particular downloadable application that is hosted on one of the Remote Application Hosts 709. The Retriever 701 typically activates the Remote Fetcher 702 to retrieve such applications hosted on Remote Application Hosts 709, when such hosts are accessible via public protocols. In one embodiment, the Local Fetcher 703 may be optimized to quickly retrieve locally stored data, whereas the Remote Fetcher 702 implements the public protocols necessary to retrieve applications that reside on hosts that are accessible across a public network. .

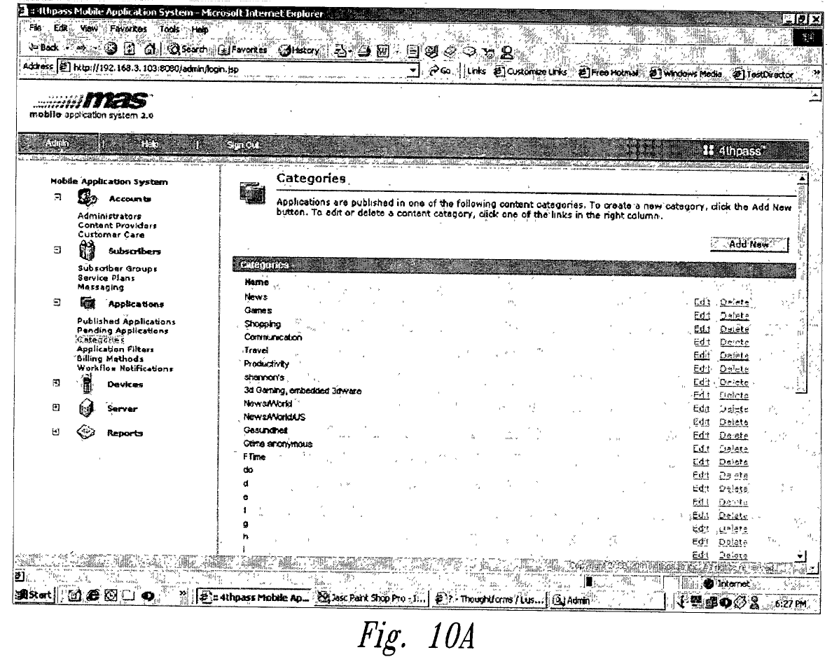

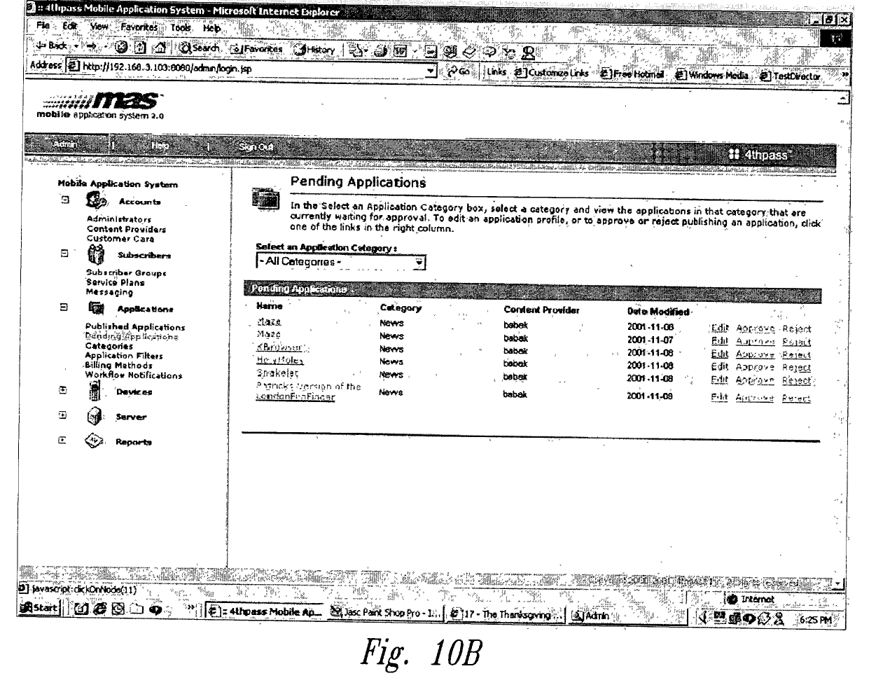

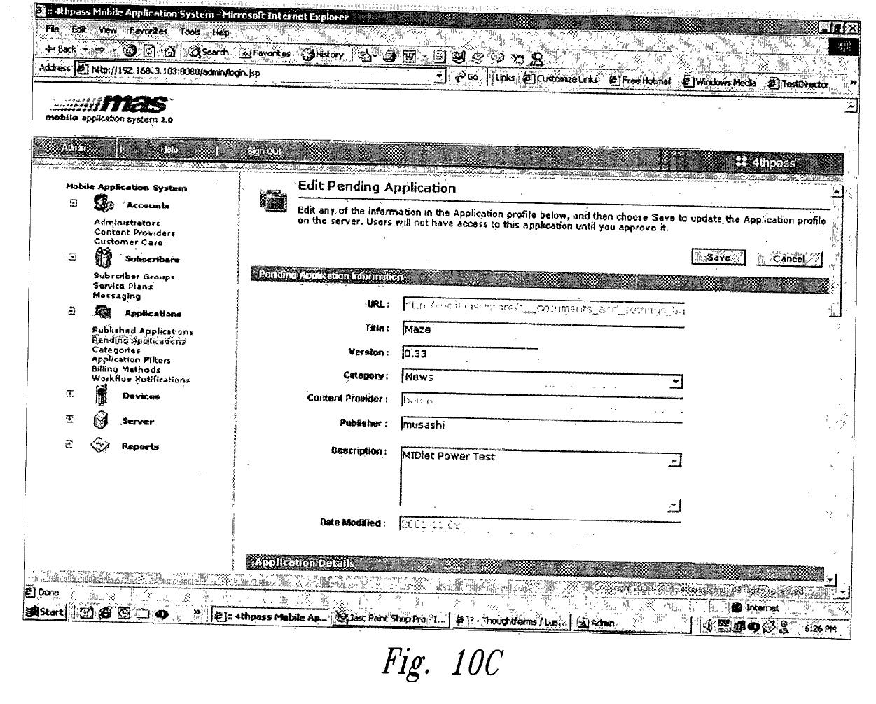

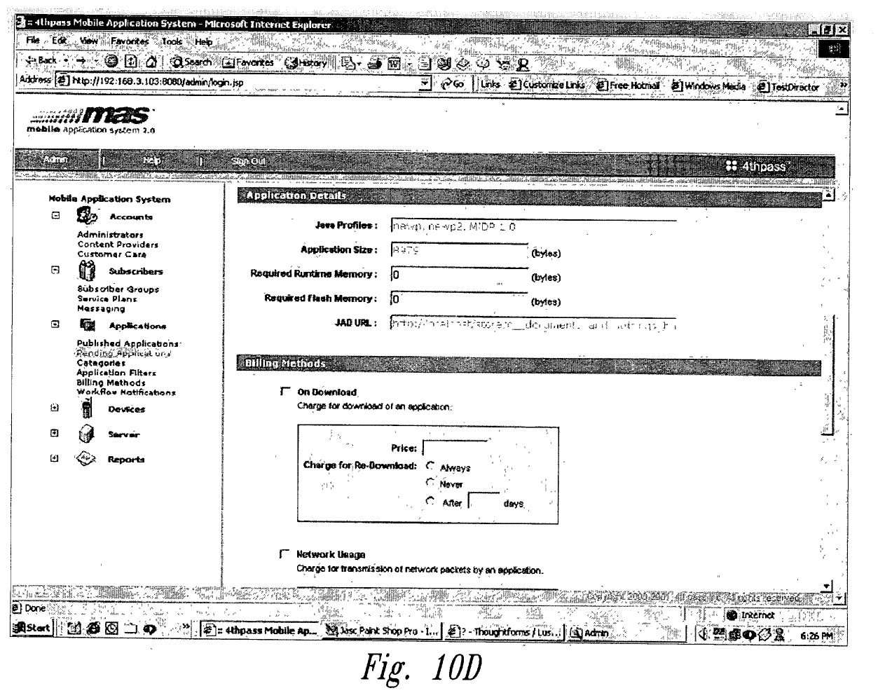

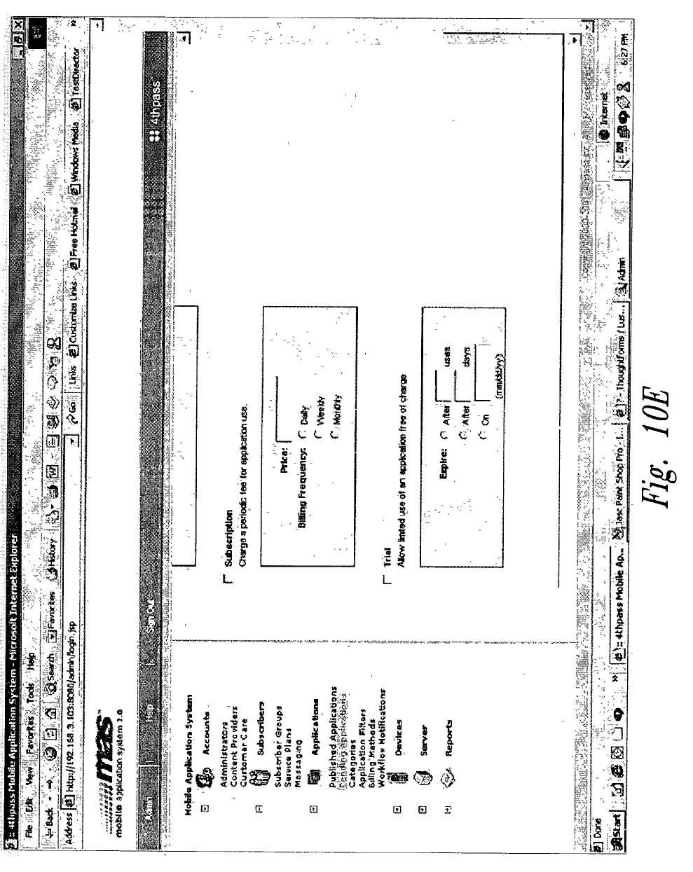

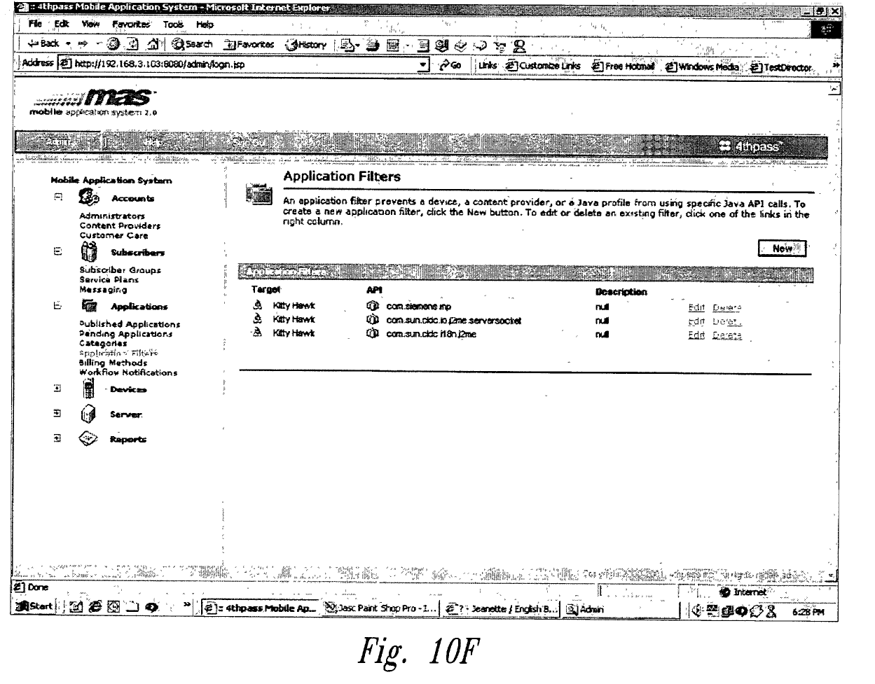

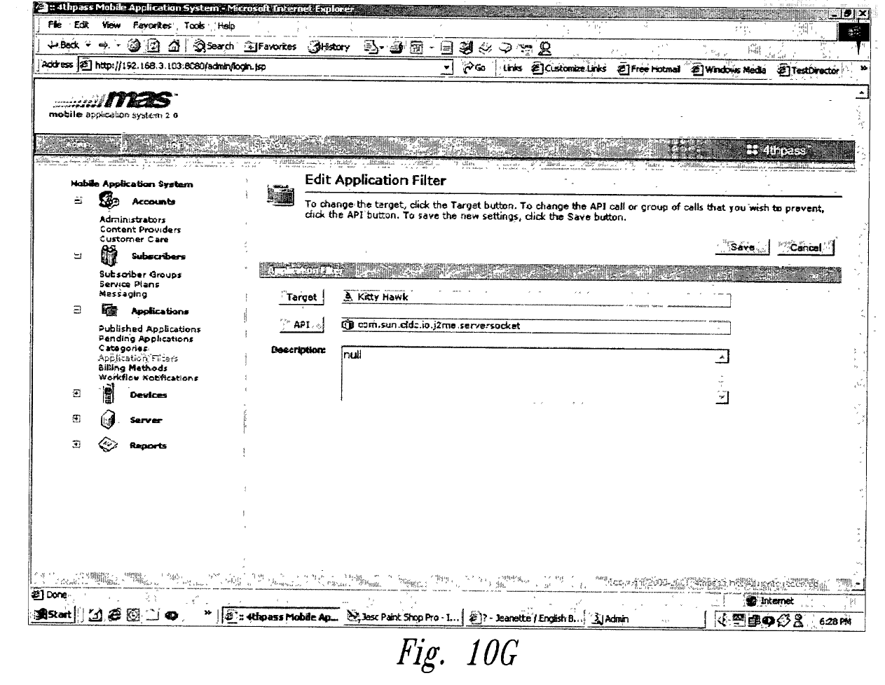

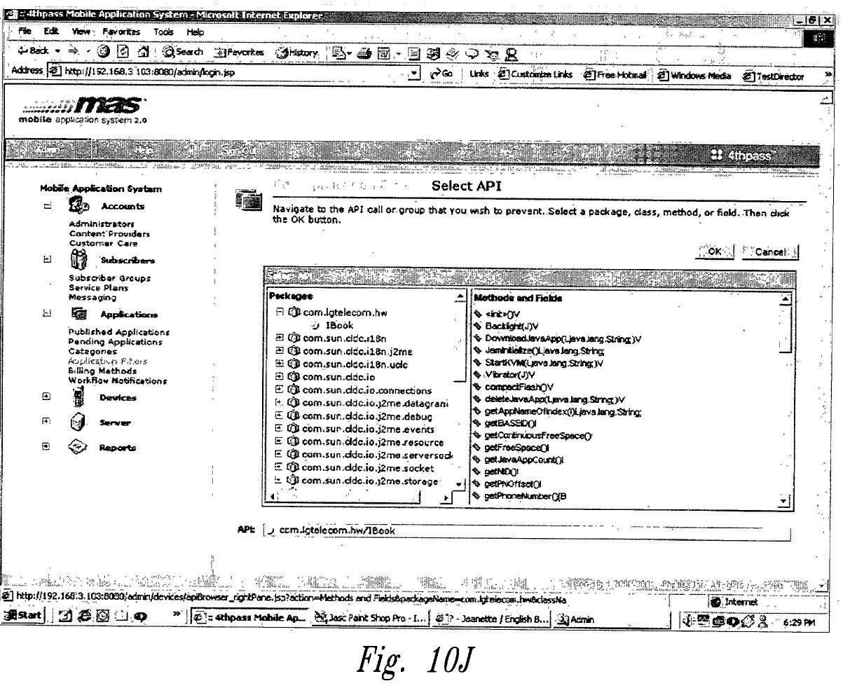

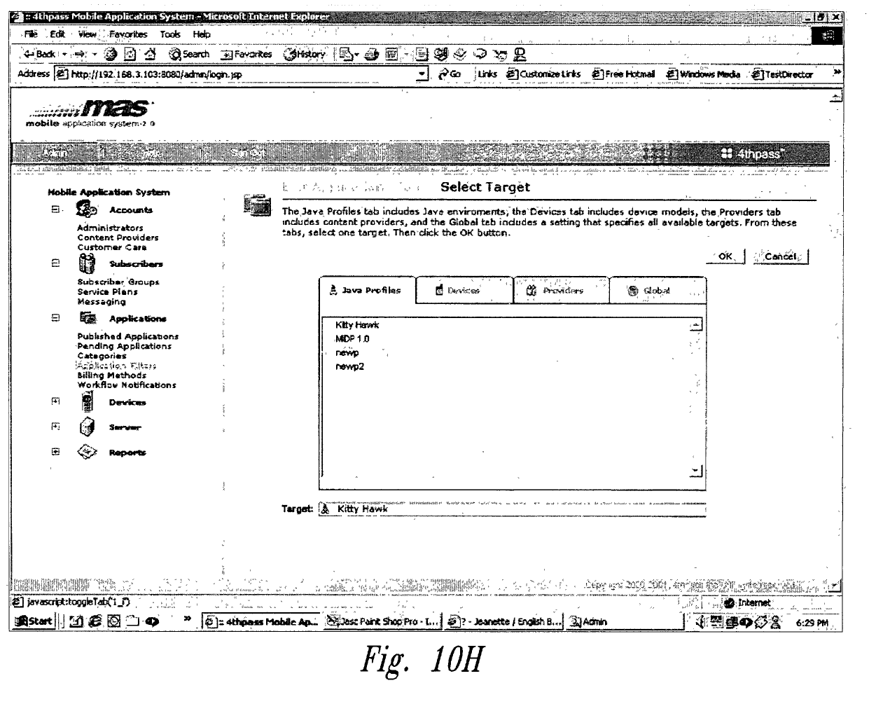

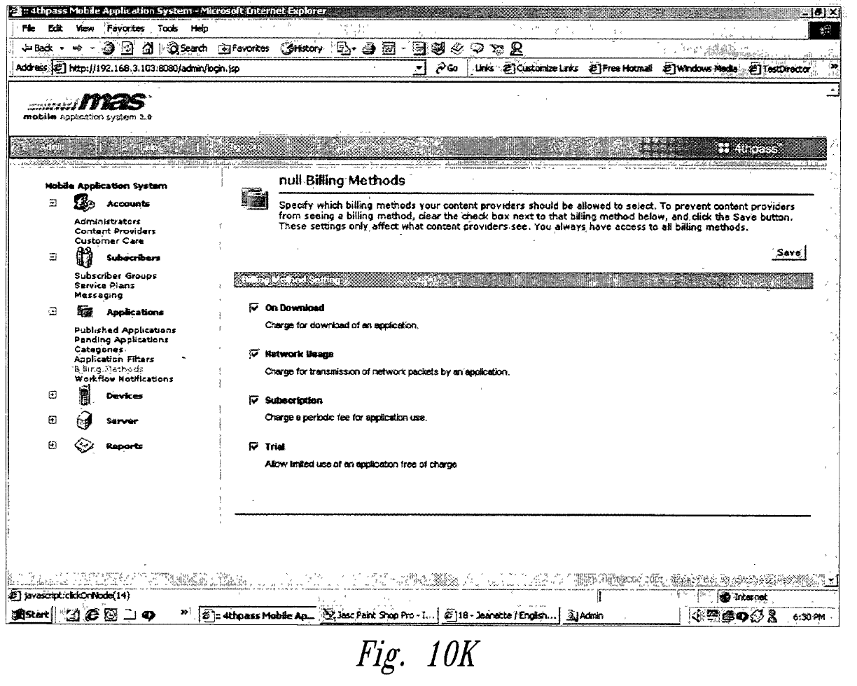

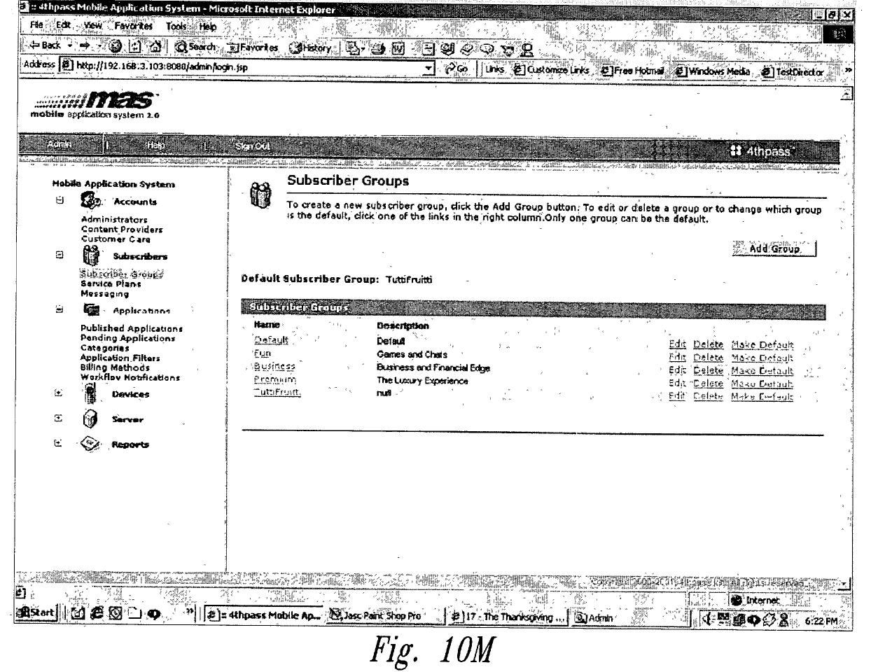

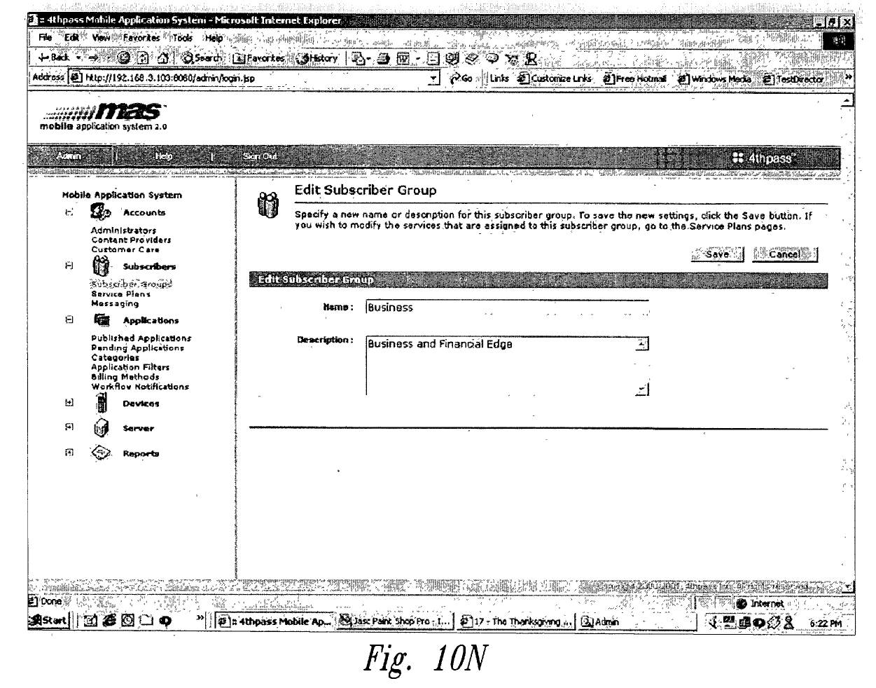

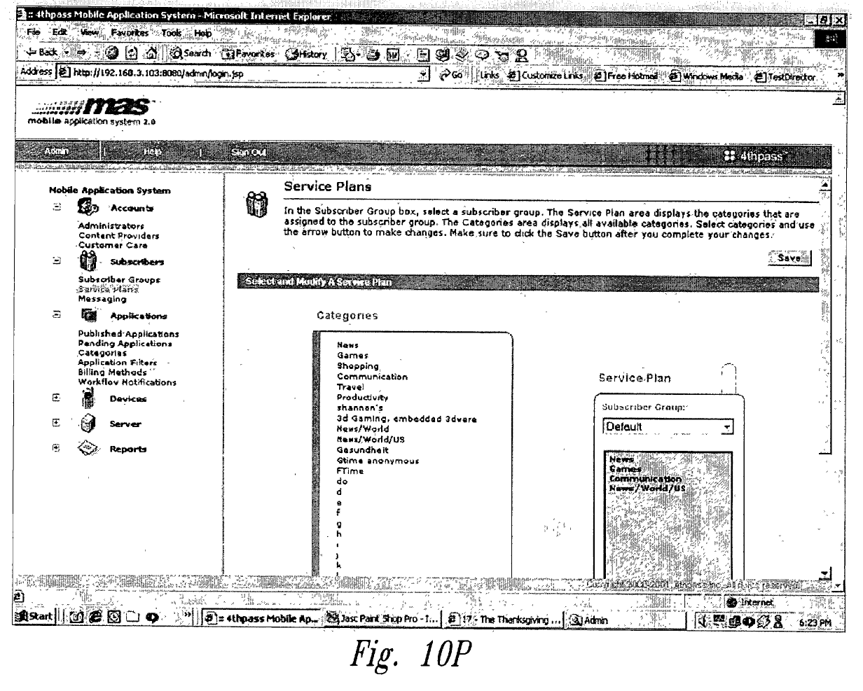

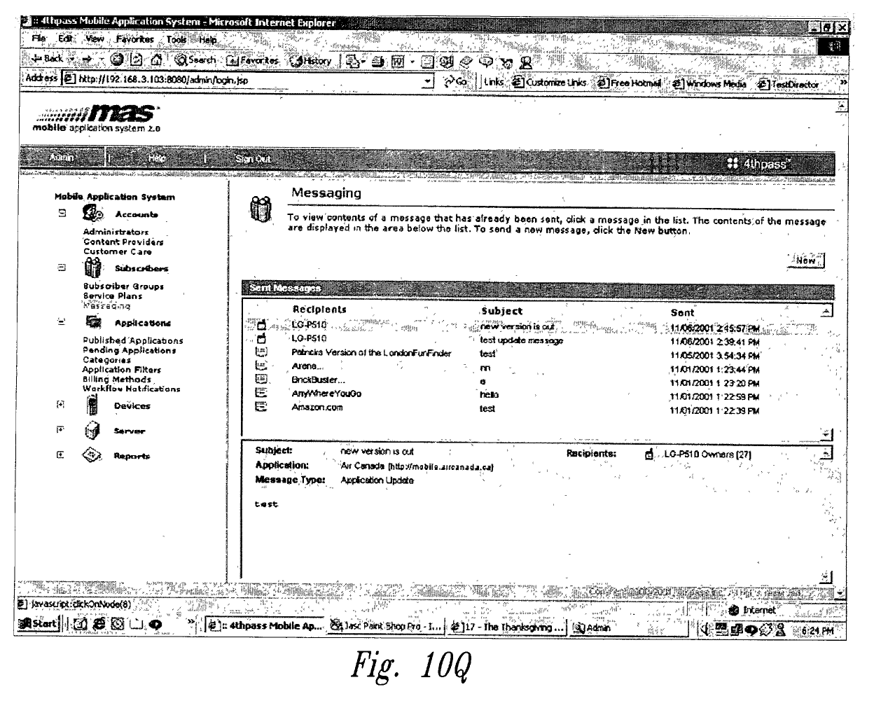

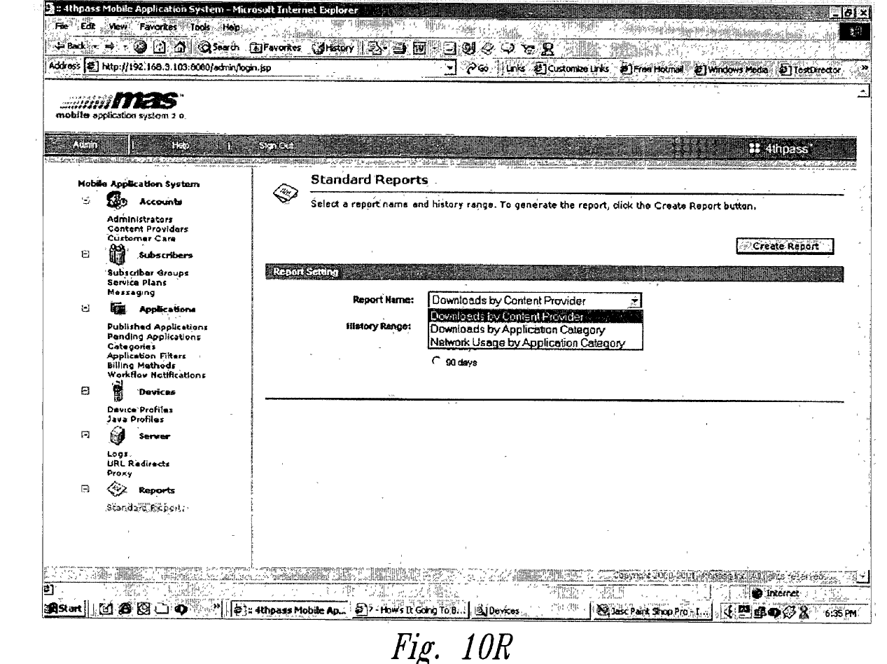

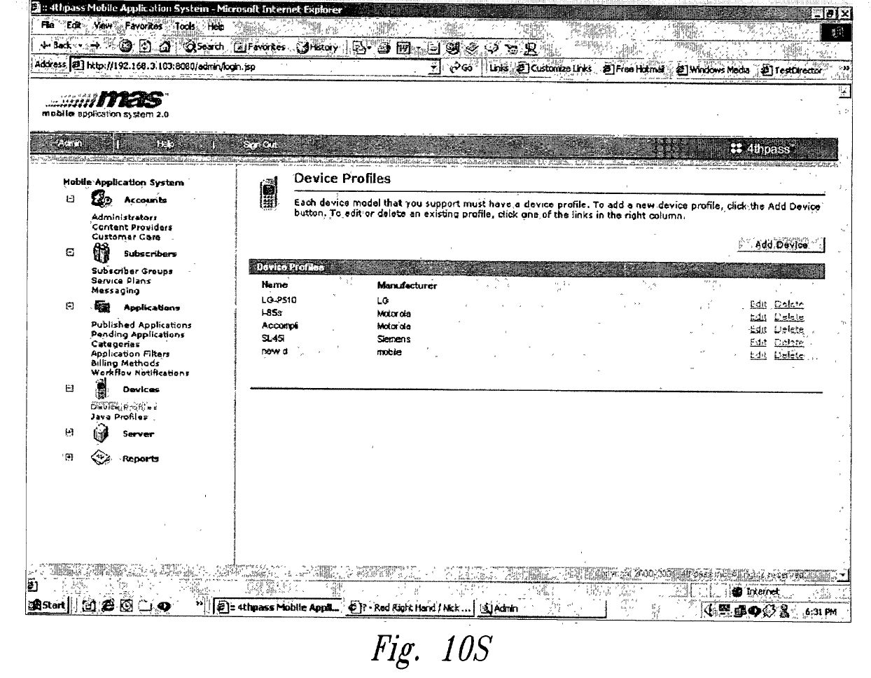

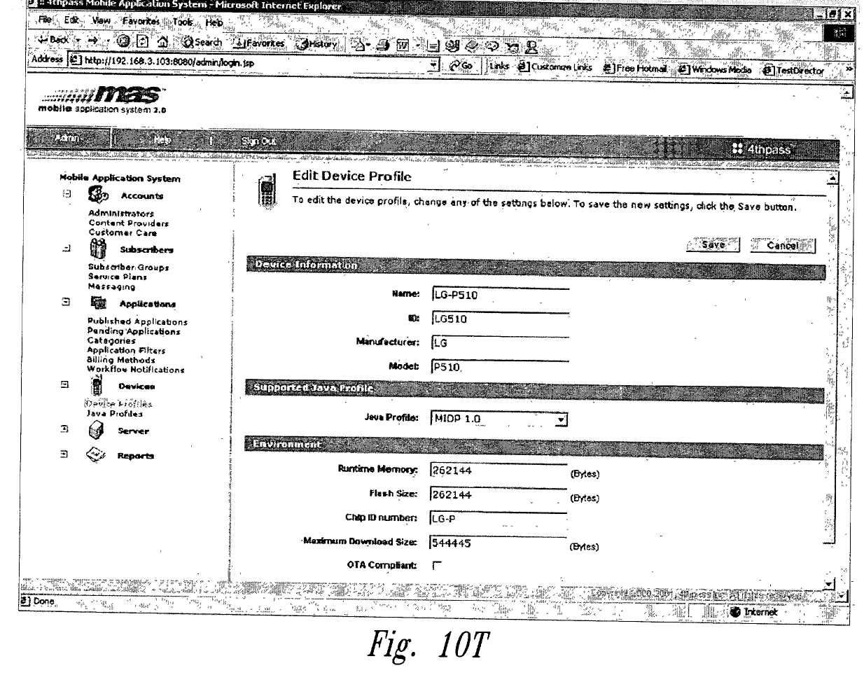

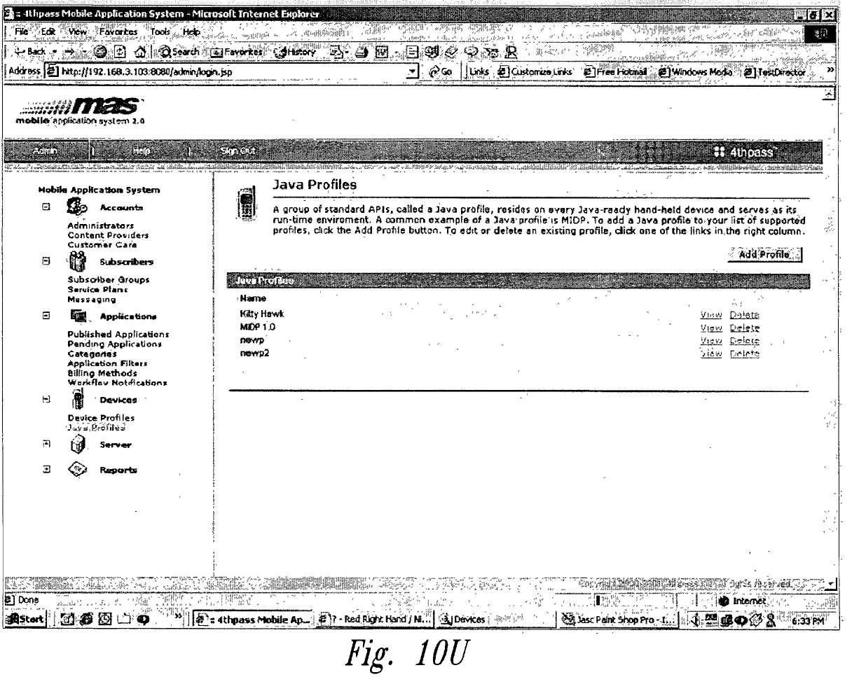

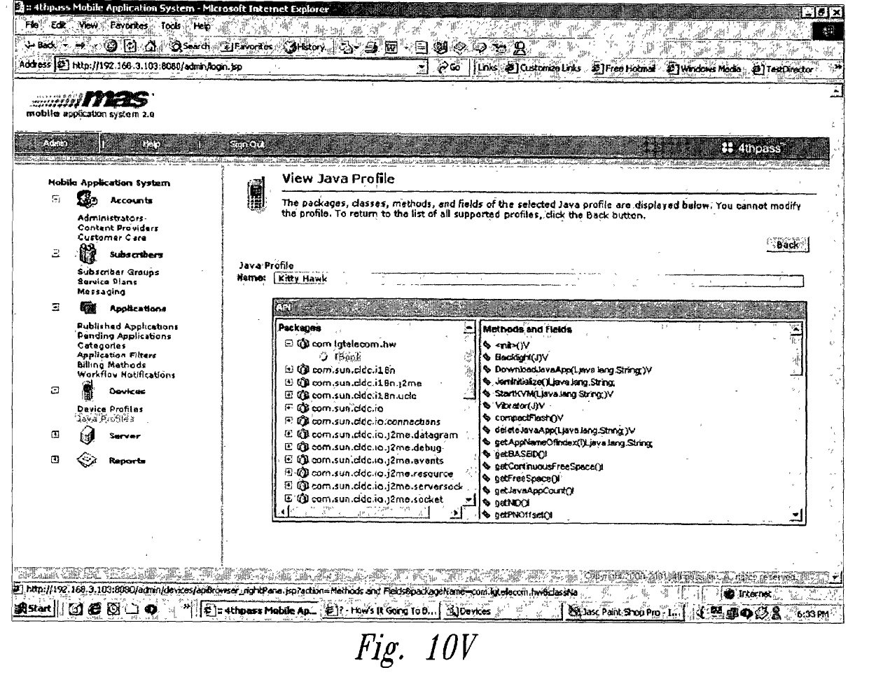

Depending upon preferences of a trusted third party host or the carrier, the application code retrieved by the Retriever 701 may be already provisioned. If the Retriever 701 obtains unprovisioned code, the code is sent to the Inspector 704, Optimizer 705, and Instrumentation Installer 706 for further processing. The Inspector 704 examines the retrieved unprovisioned application code to detect malicious code. On Java code, the Inspector 704 may also perform a class analysis of the application code to verify that classes in the application conform to desired standards such as the number, type, and frequency of API calls. In addition, the Inspector 704 applies application filters to detect package and method names, classes, fields or other forms of an API that are suspected to have intrusive, malicious behavior, or that may be unauthorized for use by the requesting subscriber, the target device, or some other target. The Inspector 704 may also apply application filters to detect API usage patterns. Application filters are a security technique discussed further with reference to FIGS. 10F-10J. The Inspector 704 has available for its use the subscriber and device profiles that were retrieved by the Provisioning Manager (as described with reference to FIG. 6) so that the Inspector 704 can enforce restrictions on a per device or per subscriber basis. In an example embodiment, the Inspector 704 allows the thresholds of such parameters to be adjusted, as well as the thresholds for flagging parameters for further inspection by other entities such as the Logging Manager, for example. If the Inspector 704 discovers potentially malicious behavior, the provisioning (and subsequent downloading) may be prevented (or the subscriber warned), and the violation along with the identity of the offender reported to the Logging Manager. .

After the Inspector 704 has successfully examined the retrieved unprovisioned application code, the code is forwarded to the Optimizer 705 for further processing to reduce the size of the application. The Optimizer 705 uses well-known methods in the art to shorten variable names and to remove unused code from the application. Such optimization procedures typically result in faster downloads. The Optimizer 705 may also use techniques that are well-known in the art to increase the speed of the application when it is executed, such as changing the use of particular instructions to more efficient instructions. One skilled in the art will recognize that, because components of the MAS may be extended or modified, any optimization technique can be incorporated into the system.

After optimization, the inspected, optimized application code is forwarded to the Instrumentation Installer 706 for further processing. Because the suppliers of downloadable applications typically do not have the ability to modify the requested applications for individual subscribers, it may be desirable to modify the code of an application to add subscriber-specific code. For example, billing options such as a “trial use” scheme can be implemented by inserting code into the application that causes, for example, the application to only execute a certain number of times or for only a specified period of time. Similarly, code that reports information for logging purposes or code that collects information for other billing options (such as packet-based billing which charges based upon the number of network packets transmitted) can be instrumented. Also, in the case of open provisioning, code that warns the subscriber that the subscriber is about to download and execute content from an untrusted source can be instrumented. The Instrumentation Installer 706 can also modify the code in the application according to other policies that are specified by carriers, for example, policies that implement promotions and advertising campaigns. One skilled in the art will recognize that code can be instrumented for many other purposes as well can be instrumented in predetermined locations using well-known methods such as manipulating libraries or by subclassing classes and methods.

After the Instrumentation Installer 706 has instrumented the requested application, the Application Packager 707 packages the inspected, optimized, and instrumented application. The Application Packager 707 packages the requested application by formatting the contents of the application file in a manner that the subscriber device can read, as determined from the device profile that was obtained by the Provisioning Manager, as described with reference to FIG. 6. For example, many subscriber devices are capable of reading files that are presented in a compressed “JAR” format (a Java archive format), which is a format used to compress and package requested Java applications. Because some devices may not accept a compressed JAR file, the Application Packager 807 provides custom packaging of provisioned applications for those subscriber devices that cannot accept files in compressed JAR format. One skilled in the art will recognize that such packaging converters and other converters for formats other than JAR can be installed into the Application Packager 807 using well-known techniques, such as by subclassing the packaging routines. In addition, some subscriber devices may limit the size of packets that they can receive. When detected, the Application Packager 807 can package a provisioned application for such a subscriber device into multiple data files that the subscriber device can assemble into a single JAR file upon receipt, which can then be used by the subscriber device to install the application.

As mentioned with respect to FIG. 5, the Administrator component (e.g., Administrator 509) may be used by different types of users to configure the various components of the Mobile Application System and to specify preferences. FIG. 8 is an example block diagram of an Administrator component of a Mobile Application System. In one embodiment, the Administrator 800 preferably provides multiple Web-based user interfaces to allow content providers, system (carrier or MAS) administrators, subscribers, and customer service support staff to access the components of the MAS or to customize their experiences. In particular, the example Administrator provides a Content Provider Website 801, an Administration Website 802, and a Personalization Website 803. Examples screen displays of these interfaces are shown below and described with reference to FIGS. 8-11. One skilled in the art will recognize that each described website may comprise multiple screen displays, and that these and/or other screen displays and websites may be combined in various configurations to achieve the same result. For example, the Administrator Website 802 may be optionally include a separate Customer Care Website 804, which can be used by a customer care representative (of typically the carrier) to manage individual subscriber accounts on behalf of the carrier.

The Administrator 800 provides a Content Provider Website 801 for content providers to use to submit downloadable applications to the MAS and to monitor whether the submitted downloadable applications have been reviewed (e.g., inspected) and approved for publication. Content providers can also use the Content Provider Website 801 to recommend changes to an application profile, to monitor the popularity of their applications, or to send communications to a MAS administrator. In one embodiment, a content provider logs into an account (previously configured using the Administration Website 801) on the Content Provider Website 801, and enters a reference to the location of a file (e.g., a URL or other location reference) that the content provider desires to submit. FIG. 9A is an example screen display of an application submission screen of a Content Provider Website. The content provider chooses whether to host the application on a carrier's application store or on a remote server. In a Java-based embodiment, the submitted file is preferably a JAD or a JAR file, however one skilled in the art will recognize that other formats and other languages also may be supported. After the file is submitted, the Administrator (for example, Administrator 509 of FIG. 5) inspects it to determine if the submission should be approved. In one embodiment, the Administrator performs many of the verification checks and inspections performed by the Provisioning Manager and the Deployment Manager (described with reference to FIGS. 6 and 7, respectively) and that, in some systems, the Administrator, the Provisioning Manager, and the Deployment Manager may be, partially or completely, combined. In one embodiment, the Administrator checks the submitted URL to make sure it is valid and not used by another application profile and downloads the application referred to in the JAD. It then analyzes the application code to make sure it matches the JAD file, doesn't use any APIs forbidden by active application filters and other verification procedures. For example, the Administrator can perform a detailed class analysis, creating a list of APIs that the application uses. The Administrator can then examine the APIs listed against any relevant application filters and can decide to reject the content. In addition, the Administrator can compare the APIs listed to the available device profiles to provide a list of devices that support these APIs to the content provider. The content provider can confirm that the application will run on all of the suggested target devices or can deselect those that should not be targeted. In the case of signed applications, the Administrator also checks to make sure signatures are valid. One skilled in the art will recognize that the inspection provided by the Administrator may be programmatically extended to include other verifications and to meet special validation needs as they arise. For example, the Administrator may also automatically verify class files that are dynamically loaded by a specified JAR and replace them if desired. Other parameters that limit the applicability of the content to specific devices can also easily be added to the submission verification process and/or to the verification processes performed at download time.

Once the application has been located and inspected for submission, the Content Provider Website 801 preferably requests additional information from the content provide about the application be submitted, which becomes part of an application profile when the application is approved. For example, the content provider may include a name and a short description of the application, a list of supported Java profiles (which are compared with device profiles to determine devices capable of running the application, the language in which the application was written, and billing information such as a suggested sales price and trial use parameters). FIGS. 9B and 9C are an example screen displays of an additional information submission screen of a Content Provider Website. Specifying this information, including the application source language, allows the MAS to store and support functionally equivalent programs having the same name that are capable of running on multiple kinds of devices that even may be written using different languages. The content provider may also select a subscriber category to which the submitted application belongs, suggest a price, list a Java profile, specify memory requirements, particular compatible devices, etc. In one embodiment, the content providers selections are considered recommendations that can be overwritten through the Administration Website 802.

After the content provider submits the additional application information, the Administrator may notify the wireless carrier system administrator of the submitted application and request approval from the carrier for the submitted application. FIG. 9D is an example application submission notification generated by an Administrator. The Administrator uses the information submitted by the content provider (which includes the submitted application) and the data generated during the inspection process to create an application profile, which is stored and maintained in a data repository (e.g., data repository 511 in FIG. 5) for use in the verification process of the Provisioning Manager (as described with reference to FIG. 6). Content providers may also use the Content Provider Website 801 at other times to view and edit their own lists of published and pending applications.

The Administrator 800 also provides an Administration Website 802 for MAS system administration, for example, to manage the published and pending applications submitted by content providers. In one example embodiment, the Administration Website 802 interface provides separate nodes to establish, configure and/or manage accounts, applications, subscribers, devices, servers, and reports. Various example screen displays that provide a user interface to these nodes are shown in FIGS. 10A through 10V.

System administrators use the accounts node of the Administration Website 802 to set up accounts for administrators, content providers, and customer care representatives. Customer care representatives can effectively log on and gain access to a particular subscriber's account and modify it according to needs. For example, a customer care representative can change a subscriber account to restart a trial period for a particular application.

System administrators use the applications node of the Administration Website 802 to manage published and pending applications, to manage application categories, to define application filters used in the application (content) verification process, to globally manage billing methods, and to setup pending application workflow notifications. In the MAS, applications are typically published in different content categories that are maintained by a system administrator. FIG. 10A is an example screen display of a category maintenance screen of an Administration Website. Content categories can be assigned to different subscriber groups, thereby allowing subscribers who belong to a particular group to download applications in the categories assigned to that group. Content providers can also suggest an application category upon submission of an application to the MAS.

System administrators also use the applications node of the Administrative Website 802 to evaluate submitted applications, known as “pending” applications. FIG. 10B is an example screen display of a pending applications maintenance screen of an Administration Website. A system administrator can edit, approve, or reject any of the applications listed as pending. The administrator is responsible for evaluating the submitted application's application profile against a wireless carrier's policies with regards to provisioning submitted applications and determining whether to reject or approve the application. Typically, the system administrator is notified when an application is submitted by a content provider, so that the application can be evaluated for approval and publication. The system administrator may approve, change, or disapprove of the submitted application and its related information and update the application profile accordingly. If the application is approved, the application is posted in the carrier's application store (or becomes available from the specified trusted third-party server) so that the application is made available for subscribers to access. A message may also be sent to notify the content provider that the submitted application was approved. If changes are required to the submitted application and/or to its related application profile, a message is typically sent to notify the content provider of the content changes. If the application is disapproved, the application profile is deleted from the data repository and the content provider is notified that the submitted application was not rejected.

As shown in FIG. 10B, the system administrator also may use applications node of the Administration Website 802 to review or edit the information related to the submitted application (as stored in the application profile). FIGS. 10C-109E are an example screen displays of portions of an edit pending application screen of an Administration Website. The system administrator can modify information such as title, description, and category for example, and can change the details used for application verification and inspection, such the selection of java profile and resource requirements. In addition, the administrator can modify billing method related information for the specific application (preferably in compliance with the carrier's global billing methods). For example, the system administrator may increase the sales price of an application to increase the profit to the carrier over the price originally indicated by the content provider. The system administrator may also specify additional billing options for the application, for example, by adding trial use free of charge even when the content provider specifies only a traditional purchase option. In some embodiments, the administrator can review the results of the detailed class analysis that was performed on the submitted application during the submission process.

System administrators can also use the applications node of the Administration Website 802 to specify security settings and policies for the MAS. For example, the administrator can define application filters that are used by the Deployment Manager (for example Deployment Manager 506 in FIG. 5) during the inspection process to prevent a subscriber device having a specific device profile, a certain content provider, or applications that use a specific Java profile, or global targets from using specific APIs or patterns of APIs, for example certain Java API calls. These APIs are specified in a language dependent fashion and, for Java-based implementations, include at least package, class, methods, and field names. The ability to specify a filter for a particular target(s) is very useful when, for example, certain API or combinations of API are found to not work on particular devices or from particular content providers. By programming the MAS with such filters, the system administrator dynamically can prevent further subscriber device “damage” after a single incident has occurred or after notification from, for example, a carrier, content provider, subscriber, or device manufacturer. In addition, application filters can be applied to untrusted or unknown third party content in the open provisioning scenario, thus providing a degree of security to existing applications without modifying them.

FIGS. 10F-10J are example screen displays of portions of the application filter management interface of an Administration Website. As shown in FIG. 10G, the administrator can select particular API to be forbidden for selected targets. FIG. 10H shows an example screen display for changing the selected target to be one of a Java profile, a device profile, a content provider, or all available targets. One skilled in the art will recognize that the application filter mechanism can be extended to support different types of filters and to target different entities.

As mentioned, the system administrator can also use the application node of the Administration Website 802 to specify global billing methods supported by the carrier. FIG. 10K is an example screen display of a billing method management interface of an Administration Website. In the embodiment shown, the administrator can select multiple different billing options for charging per download, per network usage (e.g., transmission-based), and per subscription, and trial use free of charge.

Other functions are also accessible to system administrators via the Administration Website 802. For example, system administrators may use the subscribers node to manage the use of the MAS by subscribers and to establish a subscriber profile for each subscriber. The subscriber profiles maintain lists of published applications that have been downloaded by each subscriber, maintain a list of banned applications that a particular subscriber may not run, and creates and maintains the subscriber groups to which the particular user belongs. In one embodiment, these profiles are stored in a data repository in the MAS (such as data repository 511 in FIG. 5) and read by the Profile Reader of the Provisioning Manager (such as Profile Reader 652 of FIG. 6).

FIGS. 10M-10P are example screen displays of subscriber maintenance screens within the Administration Website. The administrator can create subscriber groups to which a subscriber can be assigned or subscribe (e.g., FIG. 10M-10N) and can define the content that is available to each subscriber group by associating content categories with each group (e.g., FIG. 10P). The assignment of particular content categories to a subscriber group is referred to as a service plan. (See FIG. 10P.) The MAS uses this information to determine whether a subscriber is authorized to download a requested application. Subscribers can specify changes to their service plans and thereby automatically become authorized to access the content associated with those plans. Default categories may also be provided for particular subscriber groups (such as a default subscriber group) for presenting categories of available published applications to users in that subscriber group.

The system administrator may also send a subscriber a message, such as a notification that an updated version is available for one of the applications already downloaded by the subscriber. This behavior is sometimes referred to as “push” capability. Information for contacting the subscriber is available typically from the subscriber's subscriber profile.) FIG. 10Q is an example screen display of a message interface of an Administration Website. System administrators may also use report templates and/or user-defined reports available on the reports node of the Administration Website 802 to obtain marketing data, such as trends and popular application downloads. FIG. 10R is an example screen display of a reports screen of an Administration Website. Because requests to download applications are logged by the Logging Manager (for example, Logging Manager 508 of FIG. 5) and details of each transaction are recorded in a tracking data repository (such as Data Repository 511 of FIG. 5), system administrators may query the tracking data repository to generate reports. In some embodiments, support for such queries is provided through the MAS Data Query Engine of the Provisioning Manager (e.g., MAS Data Query Engine 650 in FIG. 6). The system administrator may generate these reports using, for example, a predefined report template or a customized report template.

In addition, system administrators can choose to remotely activate or deactivate downloaded applications over the wireless network provided the Instrumentation Installer 706 has appropriately instrumented the downloaded content. For example, instrumented applications can be forced to check with the host server (carrier or third party) to see if a new version of the application is available and can prompt the subscriber to determine whether to download the new version of the application. Instrumented applications also can be forced to check with the host server to determine if a time limit period has expired or the number of times the application can be run has been exceeded (for example, for use with a trial period billing option). Instrumented applications may also place time of day restrictions that may, for example, restrict an application to be used only a certain number of times within a set time period of a day. These restrictions effectively allow system administrators to revoke or restrict the privilege of a subscriber to execute an application even after the application has been downloaded to the subscriber's wireless device. One skilled in the art will recognize that other restrictions and capabilities may be similarly enforced.

System administrators can use the devices node of the Administration Website 802 to submit and maintain information that is used for verification during the provisioning of an application. For example, system administrators can create and maintain a list of device profiles that correspond to particular devices. Typically, the system administrator creates a device profile for each device that is supported by the MAS. FIGS. 10S-10T are example screen displays of device maintenance screens within the Administration Website. New device profiles and corresponding device designations may be added as necessary. Each device profile contains hardware specific information and resource characteristics, such as the amount of runtime memory and flash memory, chip identification, maximum download size, and whether the device is “OTA” compliant. (OTA refers to Sun Microsystem's Over The Air conformance specification. Devices that conform to OTA support the tracking of successful downloads on devices amongst other capabilities.)

Each device profile can also designate a single Java profile that is supported by the device. A Java profile specifies the Java API that is supported by a device. For example, a device that conforms to the MIDP 1.0 standard (a well-known standard that defines a set of Java API implemented by the device) would typically have a device profile that indicates this conformance. (See, for example, FIG. 10T.) The device (and associated Java) profiles are used by the Provisioning manager during the verification process for comparison with an application profile to insure that a particular device has the resources and supports the set of API required by the application. FIGS. 10U-10V are example screen displays for maintaining Java profiles using an Administration Website. Although the same Java profile can be associated with multiple devices, a device can typically only support one Java profile. A system administrator loads a Java profile by specifying the name of an archive file (e.g., a JAR file or a zip file) that specifies and describes a set of APIs. The MAS examines the specified archive for its structure (package, class, method, and field definitions) and generates a profile that contains this structure. These profiles can be also used to create application filters, which prevent the provisioning and/or downloading of applications that use specific API. Although discussed primarily with respect to Java-enabled devices and Java API, one skilled in the art will recognize that the MAS can be adapted to other language specifications and other language enabled devices, as long as the language supports a determination of whether particular API, objects, classes, variables, and/or other data structures are present in an application and supported by devices and as long as structure can be ascertained at the byte-code level. In addition, one skilled in the art will recognize that these techniques can be adapted for use at the source code level, as long as the receiving application can compile or interpret the source to generate an executable file.

The Administration Website 802 enables system administrators to implement various security techniques and policies that supplement and complement the verification and inspection processes provided by the Provisioning and Deployment Managers. One such technique is the ability to define application filters, as discussed, which are used to specify API that should not be called by an application using a particular device or other target. Such restricted calls and structures can be identified during the application provisioning process in response to a subscriber request to download and upon submission of an application by content providers to help ensure that a subscriber will not load code that is inappropriate for a particular device. Another security technique provided is the ability to redirect URLs. System administrators can redirect URLs for the convenience and security of users of the MAS by specifying URL redirection mappings using the Server node of the Administration Website 802. For example, a URL that points to an unauthorized advertising site may be redirected to a URL that provides advertising from a paying advertiser. Similarly, after removing content, the system administrator may wish to redirect the URL that previously referred to the content instead to an error message. Also, redirected URLs may be used to hide the real location of an application or to enable an application to be moved more easily. Upon receiving incoming data, the MAS compares any URLs that specify an application with a list of redirected URLs managed using the Administration Website 802 and redirects them if so specified. One skilled in the art will also recognize that additional and other security techniques can be added to and utilized by the MAS and, where necessary, configured through the Administration Website 802 to provide a variety of security mechanisms to securely communicate between subscribers, content providers, administrators, and various MAS components and to securely transport data stored in the MAS, accessible through the MAS, or stored on the client device. For example, as devices are manufactured that support secure protocols such as KSSL, various MAS components can be configured to use the protocols. In addition, where applicable, secure interfaces can be installed as components between the web-based interfaces and the MAS components manipulated by them.

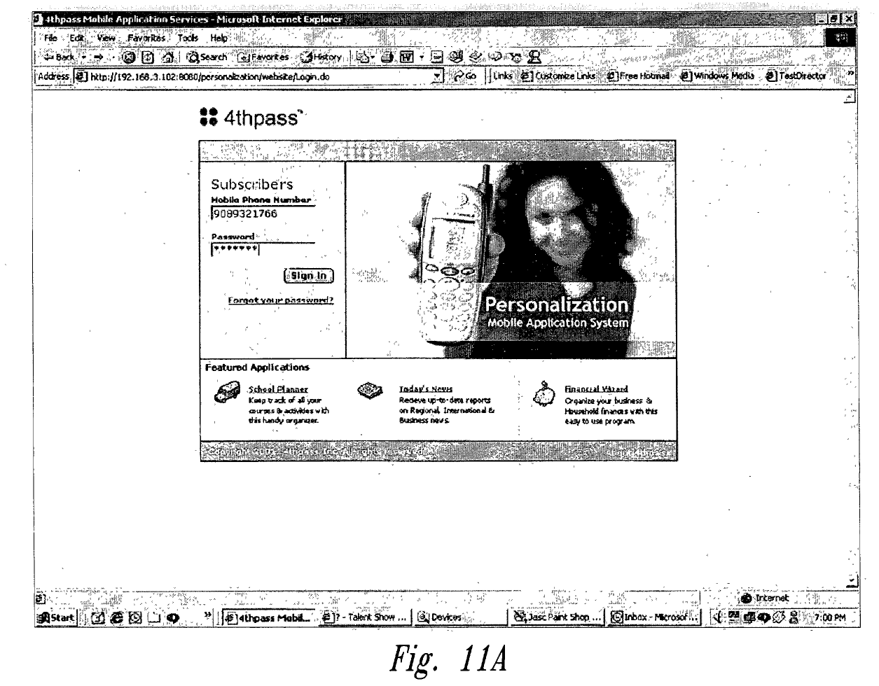

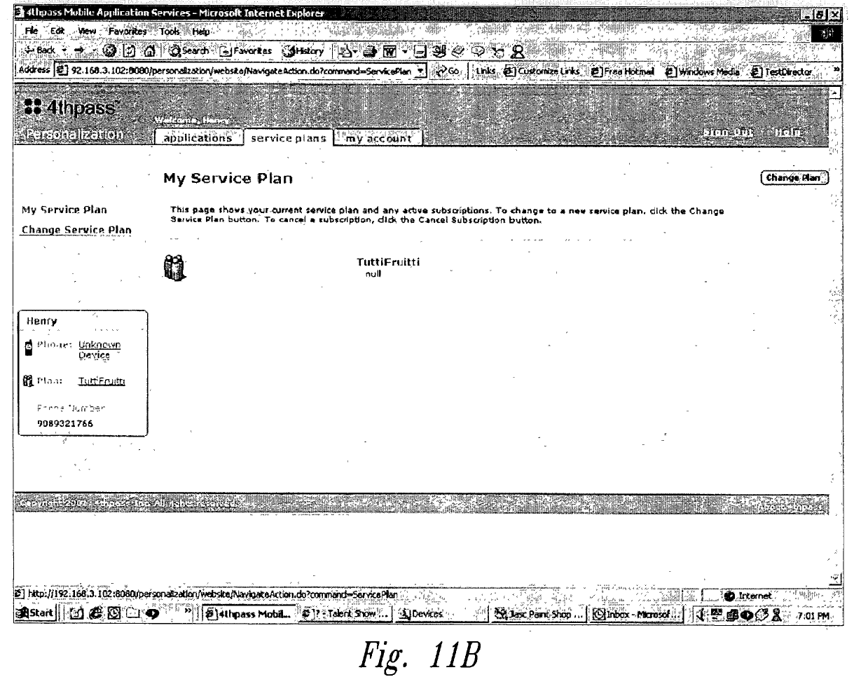

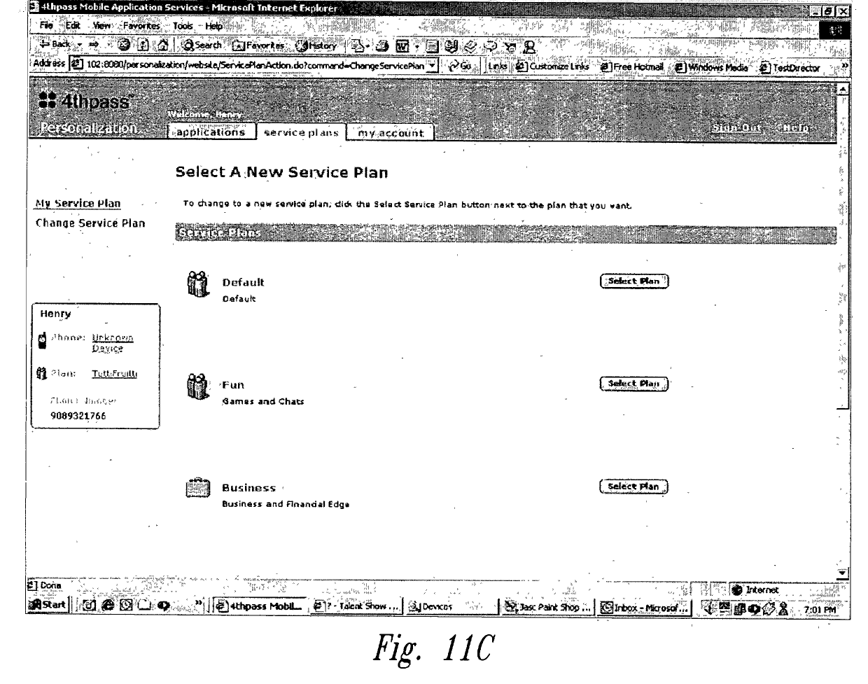

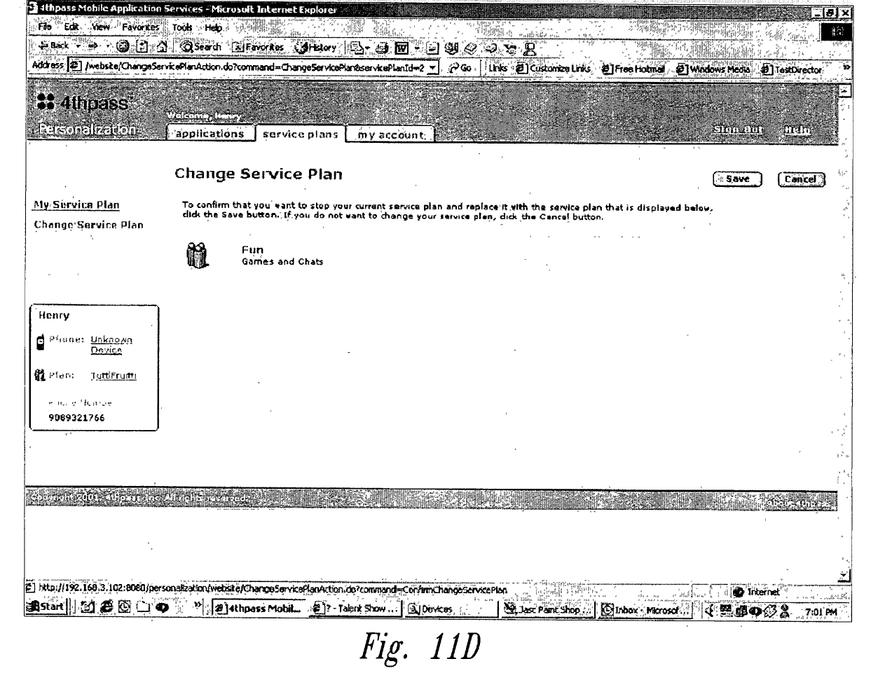

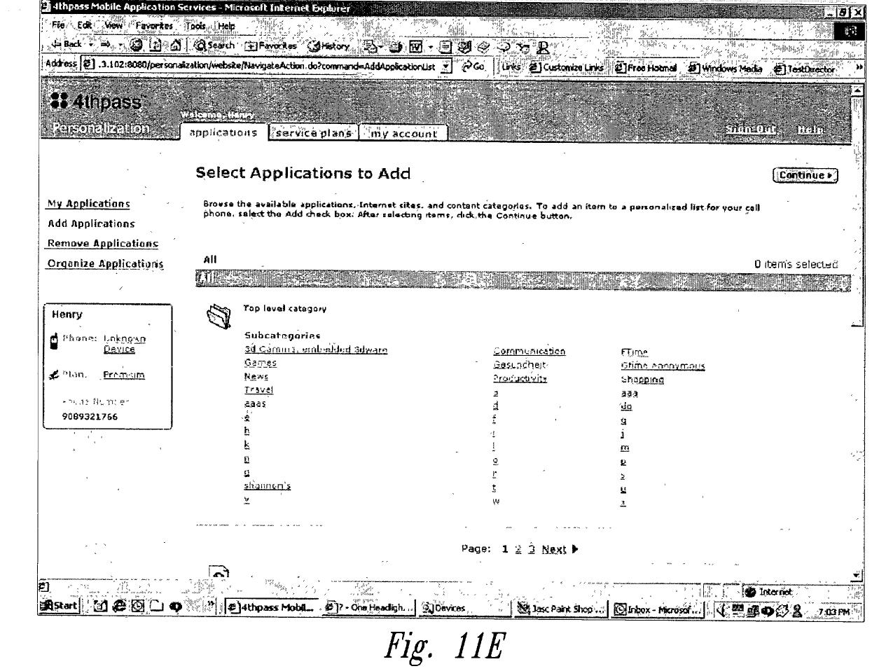

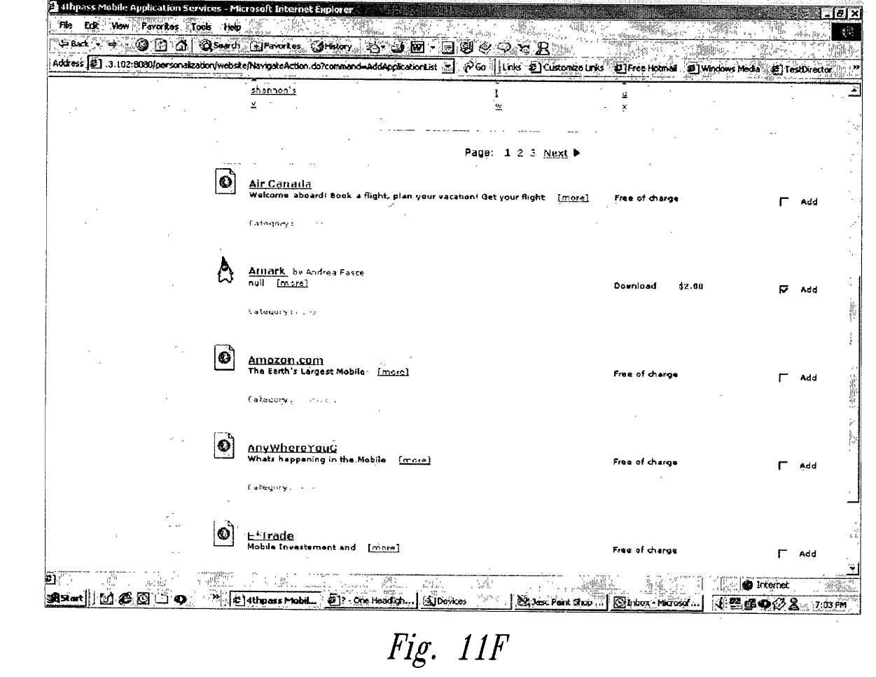

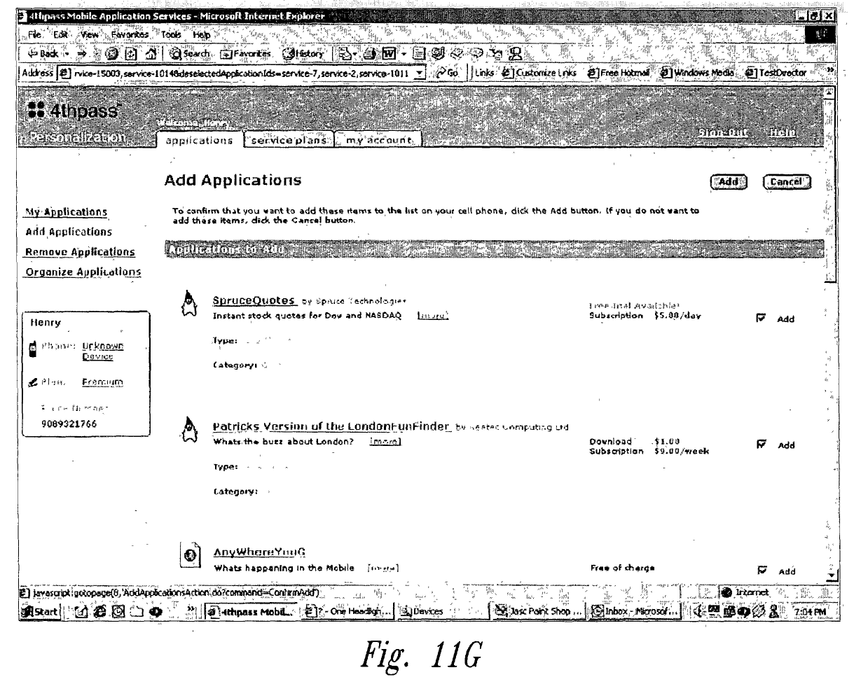

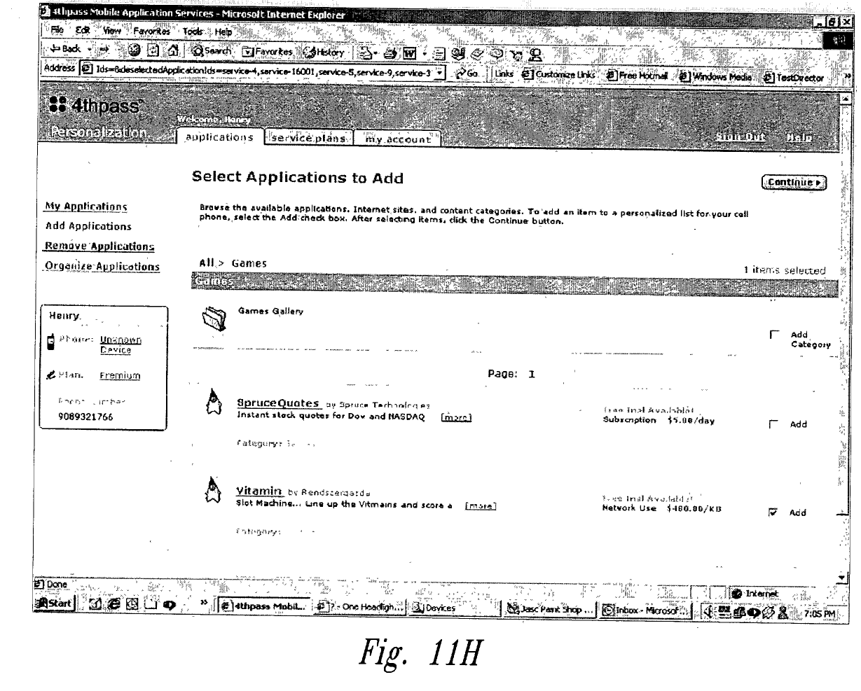

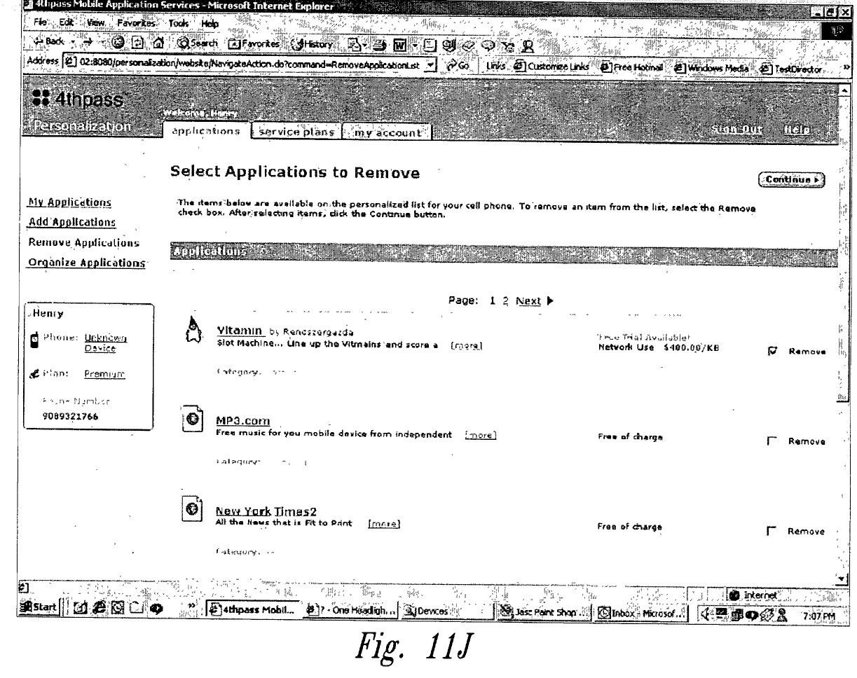

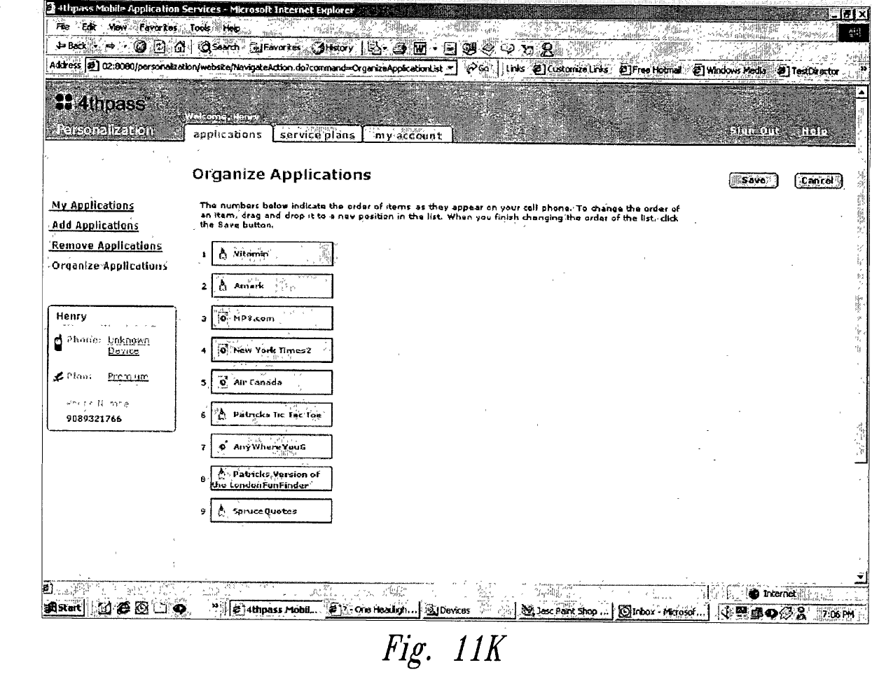

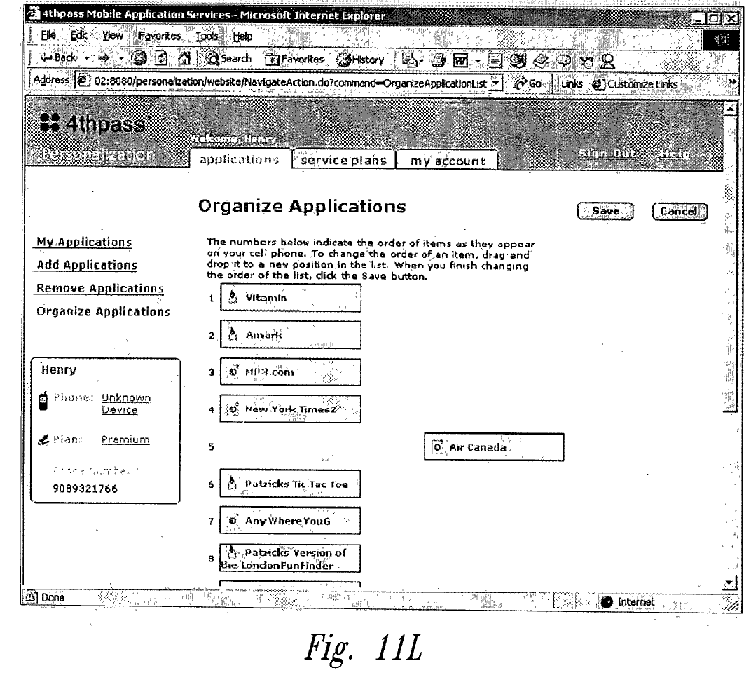

The Administrator 800 also provides a Personalization Website 803, which is used by subscribers to order, maintain, and display services and information related to the subscriber and to manage applications. FIGS. 11A-11L are example screen displays of a Personalization Website. FIG. 11A is an initial screen display of the Personalization Website. A subscriber uses the Personalization Website 803 to subscribe to additional categories of content by changing service plans (which may possibly cause a change in the amount billed to the user). FIGS. 11B-11D are example screen displays for managing service plans using a Personalization Website. When a new service plan is selected, the subscriber is then authorized to use the associated content categories.

The subscriber may also manage the subscriber's applications by viewing current applications, adding applications, removing applications, and organizing applications. FIGS. 11E-11L are example screen displays for managing applications using a Personalization Website. Although described with reference to applications, one skilled in the art will recognize that these techniques can be applied to any downloadable content and that the applications can be managed by category or other abstractions in addition to application-based management. A subscriber can use the Personalization Website 803 to create and manage the subscriber's “Personal Access List” (“PAL”). A subscriber's PAL is the list of applications that the subscriber desires to have the MAS display on the subscriber's device during, for example, application discovery. This list may include a default set of applications, no applications, or a list of applications the subscriber has downloaded or desires to download at some future time, or other combinations. In one embodiment, the PAL initially contains what the subscriber has downloaded. Because the MAS maintains records of application downloads for each and every wireless device, the MAS is able to track a particular subscriber's downloaded applications.

FIGS. 11E-11H are example screen displays for adding applications to a subscriber's Personal Access List. In one embodiment, the PAL lists the name and description of the application, the billing options that are available, the cost for each billing method, the available and status of any applicable trial period, status of the subscription, and compatibility with the subscriber's device. Applications can only be added typically if they are available under the subscriber's service plan (which can be changed) and if the are compatible with the subscriber's device. Alternatively, they can be added to the PAL, but then removed by the Provisioning Manager during application discovery. This enables a subscriber to have a PAL that works for multiple subscriber devices. The Administration component of the MAS (e.g., Administrator 509 in FIG. 5) can automatically make this determination by comparing the device profile associated with the subscriber's device with the application profile that specifies the devices upon which the application will run. In some embodiments, the MAS lists all available applications and indicates whether or not the subscriber's current service plan supports downloading of the application. In other embodiments, the MAS only lists those applications that are supported by the subscriber's device. This allows the subscriber to avoid the problem of having to explicitly select a compatible application. Other combinations are also contemplated.

Applications can also be removed from the Personal Access List. FIG. 11J is an example screen display for removing applications from a subscriber's Personal Access List. In addition, the subscriber can organize the Personal Access List according to how the subscriber intends the list to appear on the subscriber device. FIGS. 11K-11L are example screen displays for organizing the order of applications on a subscriber's Personal Access List.

By maintaining a PAL, the subscriber can easily manage which applications are loaded on the subscriber's device and can even download the same set of applications to another wireless device if, for example, an original wireless device is lost, stolen, or broken. Additionally, a subscriber can maintain copies of information such as personal contact information and appointment calendars, which can be easily downloaded to the subscriber's wireless device or another device. These features thus minimize the inconvenience in upgrading to new wireless devices.

As described, the MAS examines the PAL to display a list of downloadable applications on the subscriber's device at certain times, for example, during application discovery. The MAS automatically generates this list in a language that the subscriber's wireless device is known to be able to render (for example, XML, WML, XHTML, Basic, HTML, or any other XML based language). The MAS provides infrastructure to support any language by storing internal information (such as the PAL) in XML format and using XSLT-based functionality (e.g., as provided by the XSLT Processor 630 in FIG. 6, which uses stylesheets) to convert stored XML formatted information into any requested format, for example, WML or XHTML Basic. The rendering language that a particular user's wireless device is known to support can be determined by the MAS automatically by detecting the requesting device and the browser used by the requesting device and/or from the device profile.

A subscriber can also use the Personalization Website 803 to obtain and change account information and a history of download or account activities.

Through the Personalization Website 803, system administrators can notify subscribers of the availability of updated or new applications, or “tie-ins,” by which system administrators can display product offerings or advertisements (through “push” messaging). A subscriber may access the Personalization Website 803 using the subscriber's wireless device or using a wired device that preferably has superior display characteristics over the wireless device (such as a personal computer). When a wired device having superior display characteristics is used to access the Personalization Website 803, superior display characteristics may be used to support enhanced tie-ins.

In addition to providing various website-based user interfaces to existing MAS components, the Administrator component of the MAS (e.g., Administrator 509 in FIG. 5) enables system administrators to implement customizable provisioning-related policies through reprogramming components of the MAS itself and through defining provisioning rules. In one embodiment, reprogramming is accomplished through the Administrator Website 802; however, one skilled in the art will recognize that this functionality can be accomplished using other mechanisms, for example, by registering different components and profiles with the Administrator through a registration mechanism, or by subclassing elements of the MAS interfaces. This functionality allows subscribers, carriers, and system administrators enhanced flexibility in reviewing submitted applications, performing profile management, report generation, and server administration.

For example, a system administrator can employ profile management to implement provisioning rules. Profiles provide a data-driven technique that is inherently dynamic. By specifying various categories of service for subscribers and groups of subscribers, provisioning rules may be applied to individuals or to groups of subscribers simply by modifying various profiles, for example using the website interfaces of the Administrator component. In addition, provisioning rules can be stored in profiles that are used to determine how the categories of service are applied to individual subscribers and to groups of subscribers. The provisioning rules themselves can be modified.

Profile management allows a high degree of flexibility in defining provisioning-related and billing-related service policies. For example, the carrier may offer subscription services comprising a basic service level and a premium service level. Subscribers of the basic service might be charged individually for each application they download, whereas subscribers of the premium service would pay higher a monthly service fee, but would be allowed to download an unlimited number of applications at no extra charge. In another example, an enterprise such as a bank could negotiate with the carrier to set up a specific type of service in which the enterprise's customers would be able to download an enterprise-specific application on one type of subscriber device to allow, for example, the bank's customers to look up account balances and transfer funds. In this example, the carrier hosts the subscriber profile for the enterprise and allows the enterprise to access this information using industry standard databases such as LDAP and relational databases that are well-known to one skilled in the art.

The Administrator 800 also provides the user interfaces necessary for administering other components of the MAS. Through these interfaces, system administrators can observe different modules of the MAS, manage server-side security, and monitor system status and server performance at any time. System administrators can also manage subscriber accounts and assign various levels of administrative privileges. Server administration also includes functions such as log management and analysis tools for troubleshooting purposes.

In example embodiments, the methods and systems of the Mobile Application System are implemented on one or more general purpose computer systems and wireless networks according to a typical client/server architecture and may be designed and/or configured to operate in a distributed environment. The example embodiments are designed to operate in a global network environment, such as one having a plurality of subscriber devices that communicate through one or more wireless networks with the MAS.

FIG. 12 is an example block diagram of a general-purpose computer system and a subscriber device for practicing embodiments of the Mobile Application System. The computer environment of FIG. 12 comprises a subscriber device 1201 and a general purpose computer system 1200, which communicate via a wireless carrier 1208. Each block may represent one or more such blocks as appropriate to a specific embodiment, and each may reside in separate physical locations.

The subscriber device 1201 comprises a computer memory (“memory”) 1202, a display 1203, Input/Output Devices 1204, and a Central Processing Unit (“CPU”) 1205. A Handset Administration Console 1206 is shown residing in memory 1202 with downloaded applications 1207. The Handset Administration Console 1206 preferably executes on CPU 1205 to execute applications 1207 currently existing in the memory 1202 or to download applications from the MAS 1209 via the wireless carrier 1208 as described with reference to the previous figures.

The general-purpose computer system 1200 may comprise one or more server and/or client computing systems and may span distributed locations. In one embodiment, the MAS is implemented using Java 2 Enterprise Edition (J2EE) and executes on a general-purpose computer system that provides a J2EE compliant application server. According this embodiment, the MAS is designed and coded using a J2EE multi-tier application architecture, which supports a web tier, business tier, and a database tier on the server side. Thus, general purpose computer system 1200 represents one or more servers capable of running one or more components and/or data repositories of the MAS.

As shown, general purpose computer system 1200 comprises a CPU 1213, a memory 1210, and optionally a display 1211 and Input/Output Devices 1212. The components of the MAS 1209 are shown residing in memory 1210, along with other data repositories 1220 and other programs 1230, and preferably execute on one or more CPUs 1213. In a typical embodiment, the MAS 1209 includes Provisioning Components 1214, Data Repositories 1215 for storing profiles and configuration data, and Applications Store 1216. As described earlier, the MAS may include other data repositories and components depending upon the needs of and integration with the carrier or other host systems. The Provisioning Components 1214 includes the components of the MAS illustrated in and described with reference to FIG. 5. The Provisioning Components 1214 enable the MAS 1209 to receive requests for downloadable applications and application discovery, to verify the appropriateness of the request for use by a particular subscriber and a particular subscriber device, to customize the requested application accordingly, and to send the provisioned application to the subscriber device 1201. Applications Store 1216 is a data repository that stores applications suitable for downloading to the subscriber device 1201. The applications may be pre-provisioned (“static provisioning”) for quick downloading to the subscriber device 1201, or the applications may be provisioned upon request (“dynamic provisioning”). The Data Repositories 1215 provide data repository and retrieval services to establish levels of subscription and device capabilities (to host the profiles used in profile management) and to determine applications suitable for each customer device.

One skilled in the art will recognize that the MAS 1209 may be implemented in a distributed environment that is comprised of multiple, even heterogeneous, computer systems and networks. For example, in one embodiment, the Provisioning Components 1214 and the Applications Store 1215 are located in physically different computer systems. In another embodiment, various components of the Provisioning Components 1214 are hosted on separate server machines and may be remotely located from the data repositories 1215 and 1216. Different configurations and locations of programs and data are contemplated for use with techniques of the present invention.

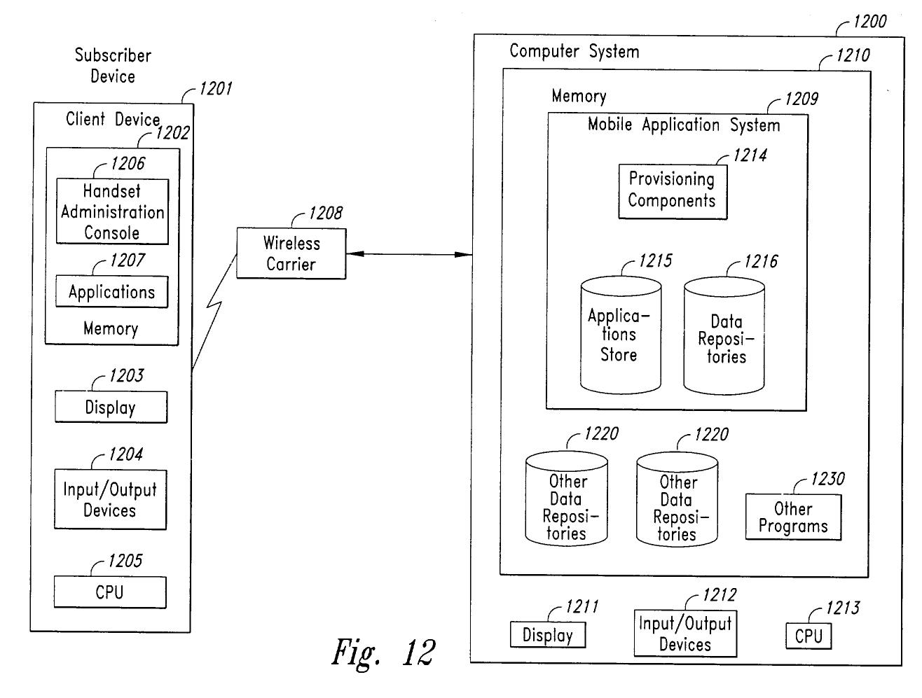

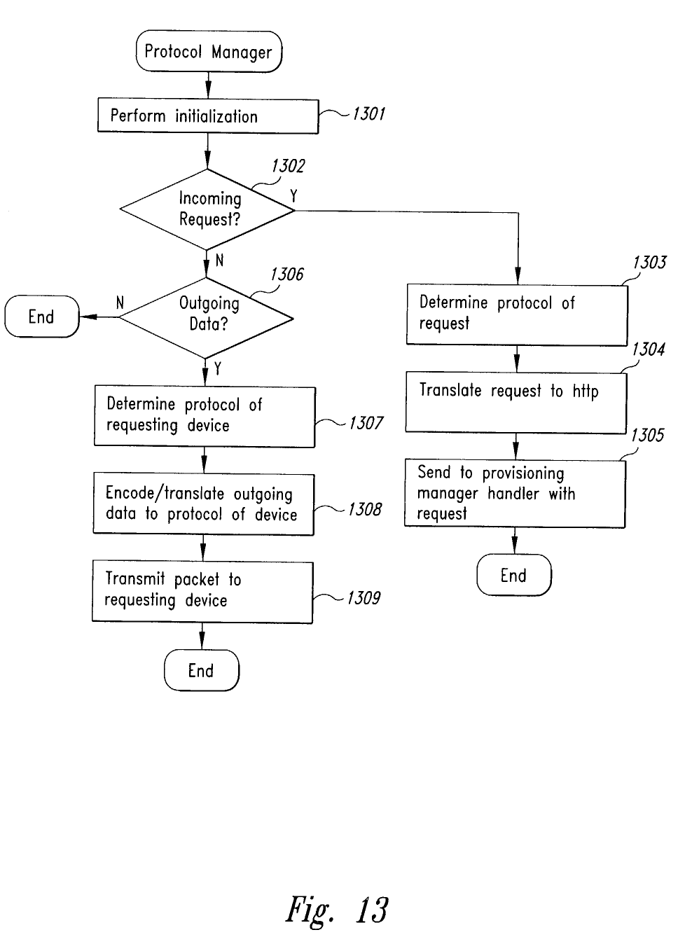

In an example embodiment, the Provisioning Components 1214 are implemented using a J2EE multi-tier application platform, as described in detail in Java™ 2 Platform, Enterprise Edition Specification, Version 1.2, Sun Microsystems, 1999, herein incorporated by reference in its entirety. The Provisioning Components 1214 include the Protocol Manager, the Provisioning manager, the Deployment Manager, the Billing Manager, among other components. FIGS. 13-28 describe various example embodiments of the specific routines implemented by each of these components to achieve the functionality described with reference to FIGS. 3-11. In example embodiments, these components may execute concurrently and asynchronously; thus, the components may communicate using well-known message passing techniques. One skilled in the art will recognize that equivalent synchronous embodiments are also supportable by a MAS implementation. Also, one skilled in the art will recognize that other steps could be implemented for each routine, and in different orders, and in different routines, yet still achieve the functions of the MAS.

FIG. 13 is an example flow diagram of processing performed by a Protocol Manager of a Mobile Application System to communicate with various subscriber devices across varying wireless networks using different protocols. (See, for example, Protocol Manager 503 in FIG. 5.) In step 1301, the Protocol Manager is initialized. In step 1302, the Protocol Manager determines whether there is an incoming data request from a subscriber device and, if so, proceeds to step 1303, else continues in step 1306. In step 1303, the Protocol Manager determines the protocol used for the incoming request by determining across which wireless network (or wired network) the request was sent, and stores the determined protocol for the pending request in a record associated with the incoming request. An association between the protocol record and the incoming request as it is processed by the system is maintained, for example, by storing a reference to the protocol record within the request message header. In step 1304, the Protocol Manager translates the incoming request to the internally used protocol (e.g., HTTP). In step 1305, the Protocol Manager sends the translated request to the Provisioning Manager (for example, Provisioning Manager 504 in FIG. 5), and then ends processing the request. In step 1306, the Protocol Manager determines whether or not there is a outgoing data request to a subscriber device and, if so, proceeds to step 1307, else ends processing the request. In step 1307, the Protocol Manager retrieves the determined protocol that is associated with the incoming request that corresponds to the output data. The determined protocol is the protocol used by the subscriber device that issued the request. In step 1308, the Protocol Manager encodes/translated the outgoing data message according to the determined protocol. In step 1309, the Protocol Manager transmits the encoded outgoing data to the subscriber device that submitted the request, and ends processing.

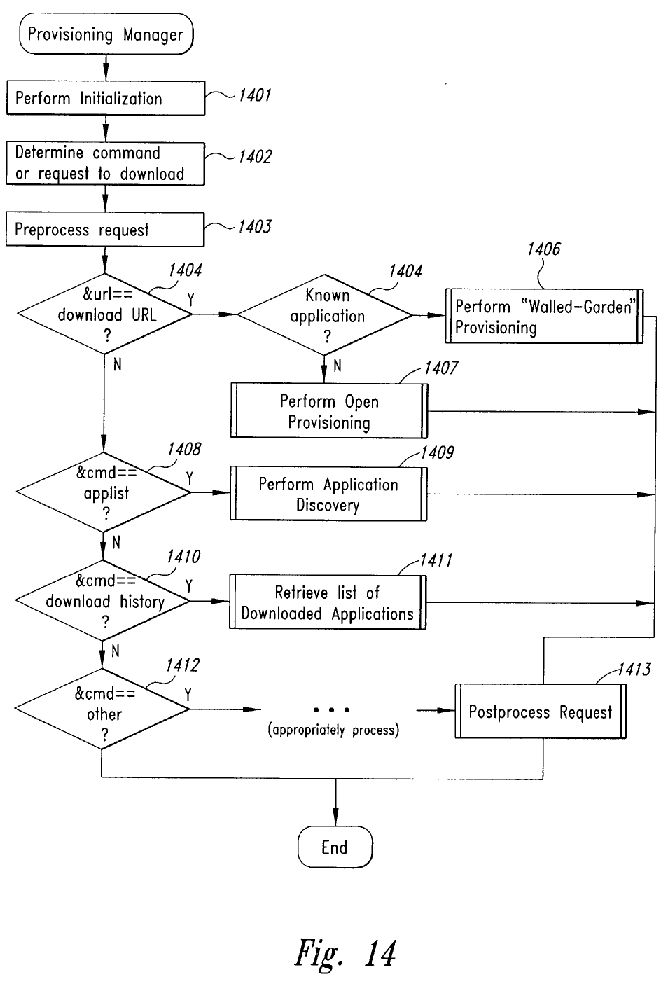

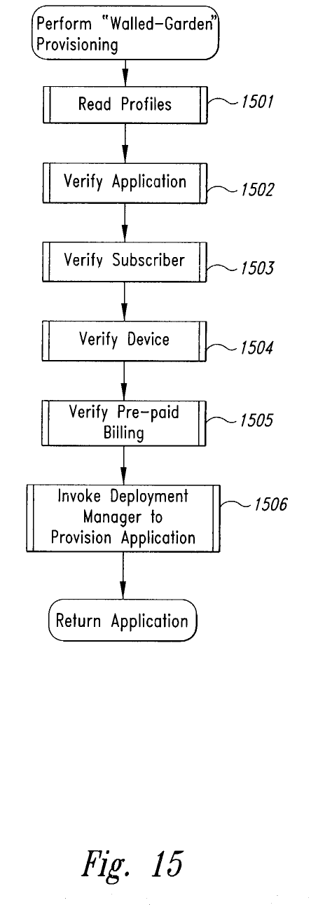

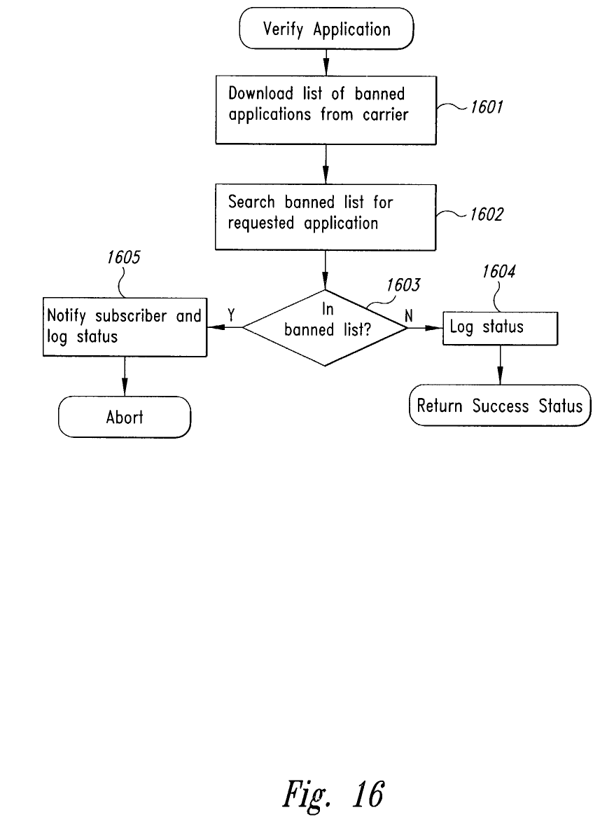

FIG. 14 is an example flow diagram of processing performed by a Provisioning Manager of a Mobile Application System to determine the suitability of a requested application for a subscriber device and to present the requested application to the device in a format that the subscriber device can decode. (See, for example, Provisioning Manager 504 in FIG. 5.) In step 1401, the Provisioning Manager performs any needed initialization. In steps 1402-1413, the Provisioning Manager processes a MAS “command.” In step 1402, the Provisioning Manager determines the command (or request to download) that is specified in the incoming request. In step 1403, the Provisioning Manager preprocesses, as described with reference to FIG. 6, the request by analyzing the incoming request and modifying the request dynamically to provide for enhancing, altering, or limiting certain provisioning steps to be taken later or by inserting other parameter values for communication or configuration reasons. In step 1404, the Provisioning Manager determines whether the “command” is a request to download and, if so, continues in step 1404, else continues in step 1408. Although currently implemented as separate “types” of commands, one skilled in the art will recognize that even though download requests are indicated by specifying a “URL” as a parameter, they are essentially commands and that there are many equivalent programmatic techniques for performing command processing. In step 1405, the Provisioning Manager determines whether the application (content) requested is known to the MAS and if so continues in step 1406 to perform walled-garden provisioning, else continues in step 1407 to perform open provisioning. In an example embodiment, there are several ways that content may become known to the MAS: through a system administrator using the website to provision and publish applications, through a content provider submitting content that eventually gets approved and published, and through a subscriber requesting the download of a yet to be known application from a trusted third party content provider known to the carrier which causes a submission process to indirectly occur. Walled-garden provisioning is discussed further with reference to FIG. 15, and open provisioning is discussed further with reference to FIG. 16. Once the provisioning has occurred in steps 1406 or 1407, the request is post-processed in step 1413. If, on the other hand, in step 1408 the designated command is a request for an application list, then the Provisioning Manager continues in step 1409 to perform application discovery, or continues in step 1410. After application discovery, the Provisioning Manager proceeds to step 1413 to post-process the request. In step 1409, if the command is a request for download history, then the Provisioning Manager continues in step 1411 to retrieve the list of downloaded applications, and proceeds to step 1413 for post-processing. In step 1412, if the command is some other MAS command, then the Provisioning Manager appropriately processes the command, and proceeds to step 1413. In step 1413, as described with reference to FIG. 6, the Provisioning Manager post-processes the request by modifying the request to contain references to instructions for directing other components of the MAS to perform functions that are extensions of the other components' functionality or modifies other parameters. For example, if the Provisioning Manager determines that the individual requesting the download is an employee of a highly valued advertising client, the Provisioning Manager may direct the Billing Manager not to bill for this particular transaction. After post-processing the request, the Provisioning Manager ends processing until another request is received.

FIG. 15 is an example flow diagram of processing performed by a Perform Walled-Garden Provisioning routine of a Provisioning Manager. (See step 1406 of FIG. 14.) In walled-garden provisioning, the requested application is verified for authorization by the subscriber and capability by the subscriber's device. Specifically, in step 1501, the Provisioning Manager retrieves the subscriber profile, the device profile, and the application profile that corresponds to the requested application. In one embodiment, these profiles are retrieved by invoking the Profile Reader 652 in FIG. 6. In step 1502, the Provisioning Manager performs application verification to verify that the requested application has not been restricted by the wireless carrier, for example due to inclusion of forbidden APIs. Application verification is discussed further with reference to FIG. 16. In step 1503, the Provisioning Manager performs subscriber verification to determine whether the subscriber is authorize via carrier billing policy or otherwise the requested application. Subscriber authorization is discussed further with reference to FIG. 17. In step 1504, the Provisioning manager performs device verification to determine whether the device has the resources and other capabilities specified by the application profile that corresponds to the requested application. Device authorization is discussed further with reference to FIG. 18. In step 1505, the Provisioning manager performs pre-paid billing verification, if pre-paid billing is included in the system, to verify that the subscriber's account is sufficient to be charged for downloading the application, as described with reference to FIG. 6. In step 1506, the Provisioning Manager invokes the provisioning interface of the Deployment Manager, and returns the provisioned application.

FIG. 16 is an example flow diagram of processing performed by a Verify Application routine of a Provisioning Manager. (See step 1502 in FIG. 15.) In summary, the Verify Application routine determines whether the carrier has banned the requested application from downloading (globally or targeted based upon other criteria such as subscriber identity, device type, etc.). In step 1601, the routine requests and obtains, a list of applications that the carrier has declined to allow to be downloaded. This list may be retrieved locally and updated on a periodic basis, for example using the MAS Query Engine 650 in FIG. 6. In step 1602, the routine searches the retrieved list for the requested application to determine if the application is banned. This provides a quick and robust way to prohibit the downloading of applications that, for example, contain or are suspected of containing malicious code. This method provides a centrally based approach (as compared to a distributed approach where each device obtains a “virus checker” and a malicious application datafile) to stop the spread of malicious applications. In step 1603, the routine determines if the request is for a banned application and, if so, proceeds to step 1605, else proceeds to step 1604. In step 1604, the request is logged, and the routine returns with successful status. In step 1605, the failed request is logged, a notification is sent to the subscriber, and the routine returns a failed status.

FIG. 17 is an example flow diagram of processing performed by a Verify Subscriber routine of a Provisioning Manager. (See step 1503 of FIG. 15.) In summary, the Verify Subscriber routine compares subscriber profiles to content categories and service plan definitions, as stored and implemented by the Administrator component in profiles (e.g., Administrator 509 in FIG. 5), and determines whether the subscriber is authorized to download the requested application. Specifically, in step 1701, the routine determines from which carrier the request message was received. In step 1702, the routine identifies the subscriber who sent the request. This may be accomplished, for example, by examining the request message for routing information. In step 1703, the routine establishes a connection with the determined carrier if subscriber profile information is stored on the carrier, and in step 1704, retrieves the identified subscriber's profile from the carrier. One skilled in the art will appreciate that the subscriber's profile may also be stored locally on and retrieved from the MAS using, for example, the Profile Reader 652 component in FIG. 6 to access a local data repository 511 in FIG. 5. In step 1705, the routine examines the request to determine which application has been requested. In step 1706, the routine determines if the subscriber's profile authorizes downloading of the requested application. This determination can be accomplished, for example, by examining the service plan of the subscriber group to which the subscriber belongs to determine whether the application belongs to a content category associated with that service plan. In addition, the routine may check for the presence of a matching banned application in the subscriber profile, and if a match is found, subsequently reject the request. In step 1707, if it is determined that the request is authorized, then the routine proceeds to step 1708, else it proceeds to step 1709. In step 1708, the request is logged and the routine returns with a successful status. In step 1709, the failed request is logged, a notification sent to the subscriber, and the routine returns with a failure status.

FIG. 18 is an example flow diagram of processing performed by a Verify Device routine of a Provisioning Manager. (See step 1504 of FIG. 15.) In summary, the Verify Device routine compares the device profile associated with the subscriber's device to the application profile for the requested application and verifies that the resources required by the application are available according to the device profile. In step 1801, the routine identifies the type of subscriber device from which the request was received. One skilled in the art will recognize that this information is determined in protocol negotiations and typically may be extracted from routing information stored in the request message. In step 1802, the routine determines the capabilities of the subscriber device by accessing a previously stored device profile that is associated with the identified device. In one embodiment, the device profile is retrieved using the Profile Reader 652 in FIG. 6. If a device profile is not found for the identified device, the event is logged and the system administrator is notified accordingly. (In one embodiment, carriers are made aware of the particular kind of device used by each subscriber when the subscriber registers with the carrier to obtain a phone number; carriers should preferably ensure that all registered device types are supported with a device profile.) The device profile contains information relevant to the capabilities of the subscriber device such as memory capacity, processor type, processing speed, maximum size of a downloadable application, etc. In step 1803, the routine determines the requirements for the requested application by retrieving and examining the application profile that corresponds to the requested application, as previously created by the Administrator component. The application profile contains the requirements for executing the application including, for example, the amount of memory required, API calls made, and minimal processor speed. The requirements may also be specified in the application profile according to types of subscriber devices that are supported. In step 1804, the capabilities of the device are compared to the requirements of the requested application by comparing the device and application profiles. In step 1805, the routine determines if the device is capable of running the requested application and, if so, proceeds to step 1806, else it proceeds to step 1807. In step 1806, the request is logged and the routine returns with a successful status. In step 1807, the failed request is logged, a notification is sent to the subscriber, and the routine returns with a failure status.

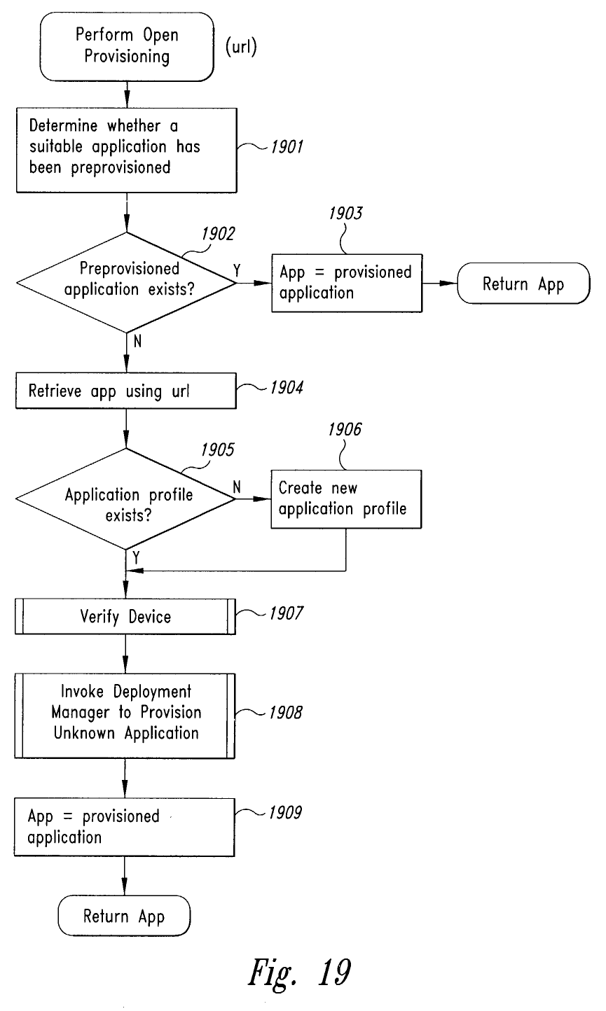

FIG. 19 is an example flow diagram of processing performed by a Perform Open Provisioning routine of a Provisioning Manager. (See step 1407 of FIG. 14.) In steps 1901 and 1902, the Provisioning Manager needs to determine whether there is a provisioned application already available or cached and, if so, continues in step 1903, else continues in step 1904. This scenario could occur, for example, if the application, even though it is from an untrusted or unknown source, has been requested and provisioned before. In step 1903, the provisioned application is returned. Alternatively, if no preprovisioned application is found, then in step 1904, the routine retrieves the application using the designated URL provided in the request message. This application may have been processed before by the MAS, and thus may have a corresponding application profile already. Thus, in step 1905, the routine determines whether a corresponding application profile exists and, if so continues in step 1907, else creates a new application profile in step 1906, and then continues in step 1907. In step 1907, the routine performs device verification by comparing the application profile (retrieved or created) to a device profile that corresponds to the device type of the subscriber's request. In step 1908, the routine invokes the provisioning interface of the Deployment Manager to provision an untrusted application, and in step 1909 returns the provisioned application.

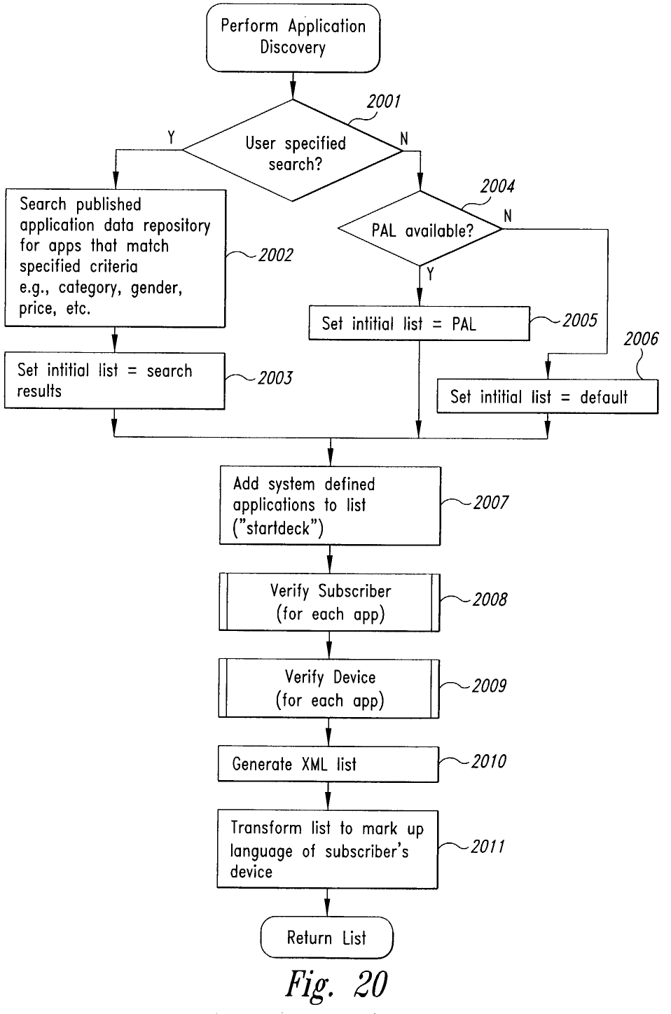

FIG. 20 is an example flow diagram of processing performed by a Perform Application Discovery routine of a Provisioning Manager. (See step 1409 of FIG. 14.) There are two basic types of application discovery: a search for applications that match a criteria specified by the subscriber and a system provided application list based upon stored subscriber preferences. Specifically, in step 2001, the routine determines whether the user has designated search criteria and, if so, continues in step 2002, else continues in the 2004. In step 2002, the routine searches the application store (a data repository of applications) and queries for applications (content) that matches the designated criteria. Example criteria include category, price, gender, age, etc. In step 2003, the list is initially set to these query results, and the routine continues in step 2007. In step 2004, the routine determines whether there is a Personal Access List (a “PAL”) available and, if so, continues in step 2005 to set the list initially to the determined PAL, else continues in step 2006 to set the list initially to a default value. In step 2007, the MAS adds a set of defined applications to the initial list, known as the startdeck. The startdeck essentially allows the MAS to reserve slots in the application discover sessions, for example, for higher revenue advertisers. In step 2008, the routine invokes the Verify Subscriber routine, as discussed with respect to FIG. 17, for each application initially on the list. Any applications not passing any one of the filtration steps 2008-2009 will be filtered from the list before the next step in the process. In step 2009, the routine invokes the Verify Device, as discussed with respect to FIG. 18, for each application initially on the list. In step 2010, the routines generates an XML for internal standardized format and in step 2011, transforms the contents of this list to an appropriate language that corresponds to the subscriber device.

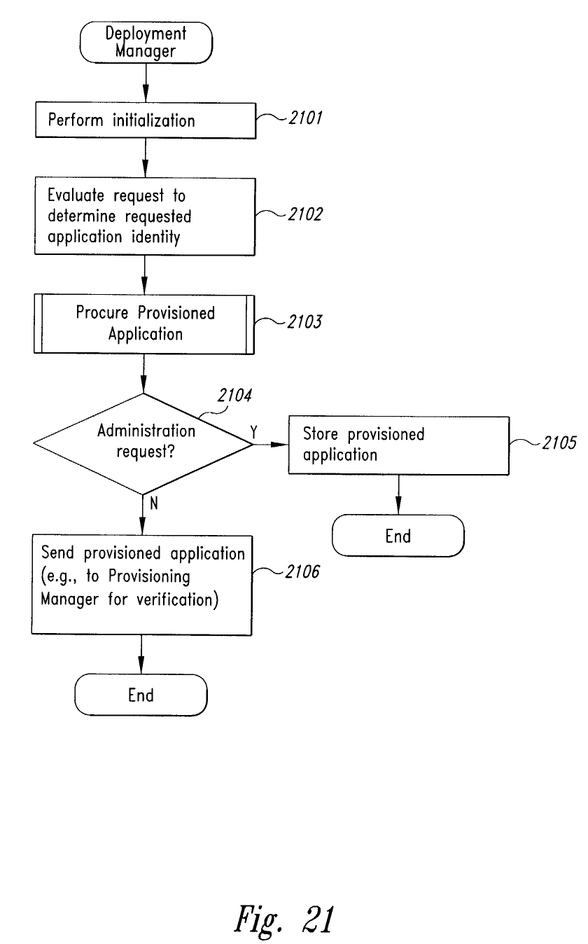

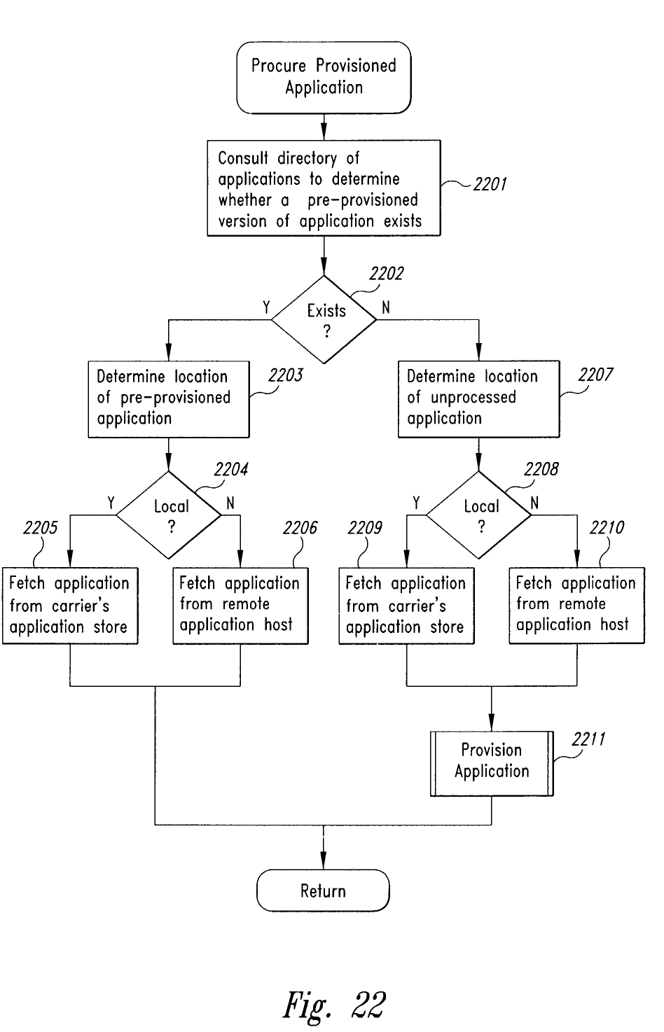

FIG. 21 is an example flow diagram of processing performed by a Deployment Manager of a Mobile Application System to provide provisioned applications in response to requests by subscribers and system administrators. (See, for example, Deployment Manager 506 in FIG. 5.) System administrators may request that popular applications for popular devices be pre-provisioned (statically provisioned) and cached for the purpose of minimizing the time required to respond to a subscriber's request. Alternatively, all applications may be dynamically provisioned, and optionally cached. In step 2101, the Deployment Manager is initialized. In step 2102, the Deployment Manager evaluates a request to determine the identity of the requested application. In step 2103, the Deployment Manager invokes the Procure Provisioned Application routine to control the retrieval of the content and to cause provisioning to occur, as described further with reference to FIG. 22. In step 2104, the Deployment Manager determines whether the request is made by a system administrator to initiate storing of the provisioned application and, if so, proceeds to step 2105, else proceeds to step 2106. In step 2105, the Deployment Manager stores the provisioned application in the cache, the carrier's application store, or a remote application host's server, depending on the policy of the system administrator, and ends processing. In step 2106, the Deployment Manager sends the provisioned application to the Provisioning Manager, and then ends processing.

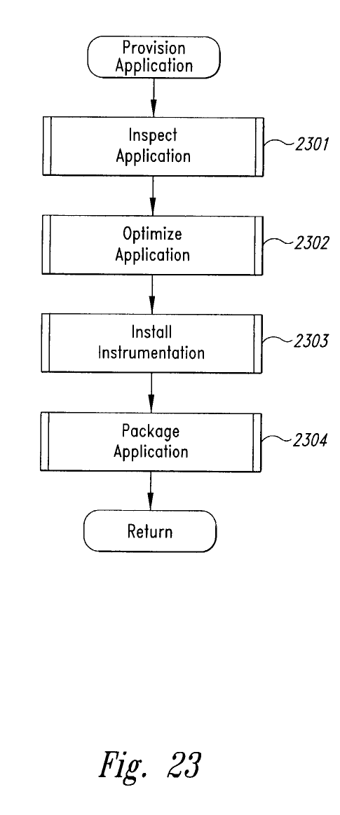

FIG. 22 is an example flow diagram of processing performed by a Procure Provisioned Application routine of a Deployment Manager. (See step 2105 in FIG. 21.) In summary, the Deployment Manager retrieves the application code and inspects, optimizes, and instruments it according to current policies implemented in the MAS. In step 2201, the routine consults some type of index to determine whether a pre-provisioned version of the application exists in a location known to the MAS. The manner in which this information is stored is related to how the cache and/or data repositories are implemented. Well-known techniques for implementing a cache using a local fast data store and index may be used. Applications may be pre-provisioned and stored when it is expected that large numbers of requests will be made for an application that would entail the same provisioning requirements. This may occur, for example, when large numbers of users who have the same kind of subscriber device request the same application. In such cases, the application may be provisioned and stored in the cache (and retrieved when requests are made by users having subscriber devices for which the application was provisioned) or stored in other MAS data repositories. In step 2202, if a pre-provisioned version of the application exists, then the routine proceeds to step 2203, else it proceeds to step 2207. In step 2203, the location of the pre-provisioned application is determined. In step 2204, the routine determines if the pre-provisioned application is stored locally and, if so, proceeds to step 2205, else it proceeds to step 2206. In step 2205, the routine fetches the application locally (typically from the carrier's application store, which may be located in the MAS or on the carrier's premises), and returns. In step 2206, the routine fetches the application from a remote application host (e.g., a third-party server) and returns. If, on the other hand, in step 2202, the routine determines that a pre-provisioned version of the requested application does not exist, then in step 2207 the routine determines the location of the unprocessed, un-provisioned application. In step 2208, the routine determines if the application code is stored locally and, if so, proceeds to step 2209, else proceeds to step 2210. In step 2209, the routine fetches the application code from the carrier's application store or other local storage. In step 2210, the routine fetches the application code from a remote application host. In step 2211, the routine provisions the fetched application, as described further with reference to FIG. 23, and returns.

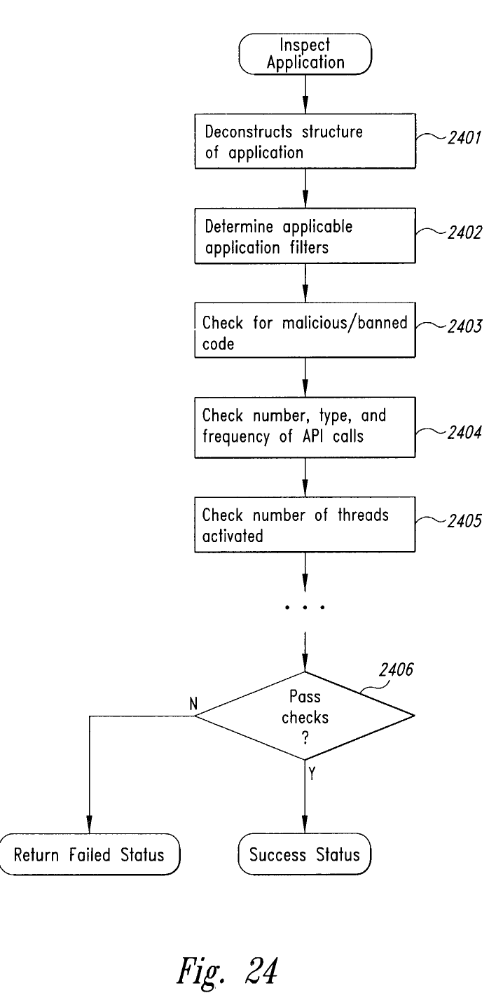

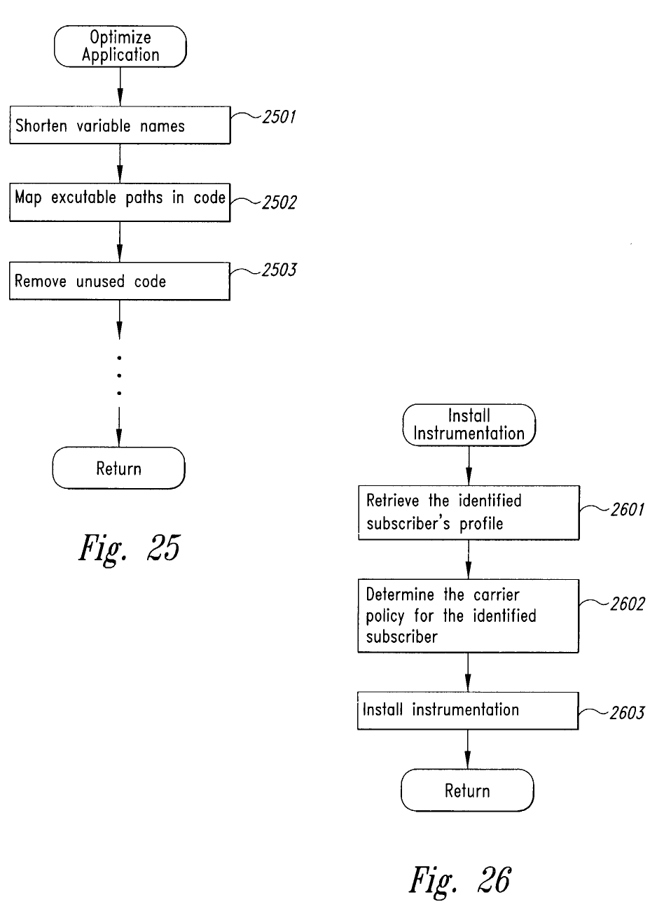

FIG. 23 is an example flow diagram of processing performed by a Provision Application routine of a Deployment Manager. In step 2301, the Provision Application routine inspects the application as described further with reference to FIG. 24. In step 2302, the routine optimizes the application as described further with reference to FIG. 25. In step 2303, the routine installs instrumentation in the application as described further with reference to FIG. 26. In step 2304, the routine packages the application in a format suitable for delivery as described further with reference to FIG. 23, and returns.

FIG. 24 is an example flow diagram of processing performed by an Inspect Application routine of a Deployment Manager. (See, for example, step 2301 in FIG. 23.) In step 2401, the routine deconstructs/decodes the structure of the application code if required to identify APIs, including packages, classes, methods, and fields, or other structures as appropriate. When the applications are coded in Java, then inspection can be performed against the binary program, with no need to insert source code level checks in the application itself to generated debugging/logging information. A set of inspection steps is described as examples in steps 2401-2405; however, one skilled in the art will recognize that other inspection steps, in addition to or instead of the ones described herein may be applied as appropriate. In step 2402, the routine retrieves any application filters that are relevant for the potential targets under examination (the requested application, the requesting subscriber, the content provider of the application, and global filters). In one embodiment, these filters are stored in a MAS data repository, however they could be stored in any known location. In step 2403, the routine inspects the retrieved application for malicious and banned code by comparing the deconstructed code with stored indications of banned data structures and API as described by the retrieved application filters. In step 2404, the routine determines the number, type, and frequency of API calls present in the code and checks whether they meet the system administrator requirements, which may be stored in the application filters. In step 2405, the routine performs a flow analysis of the deconstructed application and determines whether the number of threads activated are within the requirements of the system administrators. This flow analysis can be accomplished using techniques such as creating a directional graph of the code and applying well-known graph analysis algorithms. One skilled in the art will recognize that other checks may also be performed on the retrieved application. In step 2406, the routine determines if the retrieved application has passed inspection and, if so, returns a success status, otherwise the routine flags the failed condition and returns a failure status.

FIG. 25 is an example flow diagram of processing performed by an Optimize Application routine of a Deployment Manager. (See, for example, step 2302 in FIG. 23.) One skilled in the art will recognize that any well-known code optimization techniques can be incorporated in this routine, and what is shown is an example. In step 2501, the routine shortens variable names contained in the retrieved application for the purpose of shortening the file size of the requested application. In step 2502, the routine maps the executable paths of the retrieved application. In step 2503, the routine removes any unused code for the purpose of shortening the file length, and continues with similar optimization steps. When finished optimizing, the routine returns.

FIG. 26 is an example flow diagram of processing performed by an Install Instrumentation routine of a Deployment Manager. (See, for example, step 2303 in FIG. 23.) In step 2601, the routine retrieves the identified subscriber's profile from typically a local data repository using, for example, the Profile Reader 652 in FIG. 6. In step 2602, the routine determines the carrier's policy for the identified subscriber when using the requested application. For example, certain subscribers may be allowed to use the application on a subscription basis or even a trial basis, but others may not be allowed. As discussed above with reference to FIG. 7, the instrumentation implements certain policies. For example, it can provide a code wrapper that allows the provisioned code to be executed a limited number of times or during a given period in time. In step 2603, the routine installs the instrumentation in the requested application according to the determined carrier's policy, after which the routine returns. In an example embodiment, the Install Instrumentation routine uses byte code instrumentation techniques to insert new code or to modify existing code within the application at the binary level. The code to be instrumented may be provided directly by the Install Instrumentation routine, or may be retrievable from other data storage, for example data storage associated with different carrier policies.

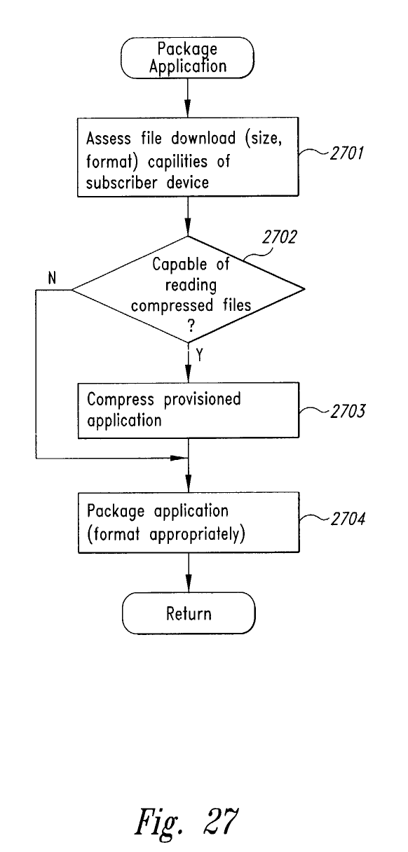

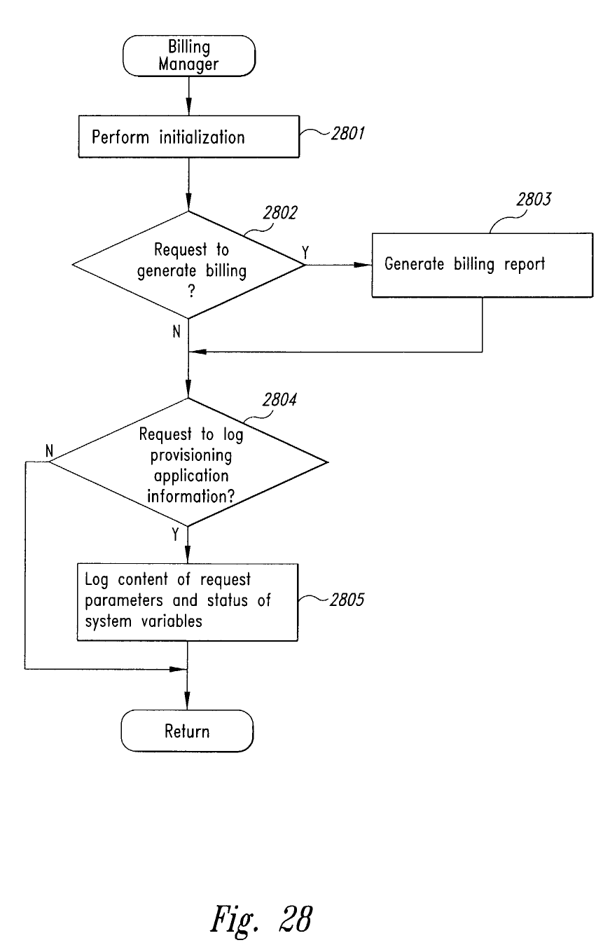

FIG. 27 is an example flow diagram of processing performed by a Package Application routine of a Deployment Manager. (See, for example, step 2304 in FIG. 23.) In step 2701, the routine accesses the retrieved subscriber device profile to determine compatible file formats for the identified subscriber device. In step 2702, the routine determines whether the subscriber device is capable of reading compressed files and, if so, proceeds to step 2703, else proceeds to step 2704. In step 2703, the routine compresses the provisioned application for the purpose of minimizing transmission time and the number of bytes transmitted. In step 2704, the routine packages the application using a determined file format by encapsulating the provisioned application with information sufficient to enable the Handset Administration Console (See, for example, the Handset Administration Console of FIG. 2) executing on a wireless device to extract the application. As described earlier, one format preferred by many Java-enabled wireless devices is compressed JAR files. In some cases, however, the application needs to be distributed to the device in smaller packets, which are reassembled on the wireless device for installation. The Billing Manager, discussed below with reference to FIG. 28, also relies on the encapsulating information for billing and routing purposes. After the application has been packaged, the routine returns.

FIG. 28 is an example flow diagram of processing performed by a Billing Manager of a Mobile Application System. (See, for example, Billing Manager 507 in FIG. 5.) In step 2801, the Billing Manager is initialized. In step 2802, the Billing Manager determines if it is time to generate a billing report and, if so, proceeds to step 2803, else proceeds to step 2804. In an alternative embodiment, the Billing Manager may respond to an administrative query, for example, from the Administrator component, to generate a billing report. In step 2803, the Billing Manager generates a billing report based on parameters set by a system administrator. In step 2804, the Billing Manager determines whether there is a request to log provisioning information (for billing purposes) and, if so, proceeds to step 2805, else it returns. In step 2805, the Billing Manager logs parameters of the request that relate to billing (e.g., the identity of the user making the request, the category of the request, the size of the download required, etc.) and the status of system variables (e.g., the date, time of day, etc.) to be used for future billing. For example, the length of the application, the time at which the application was requested, the time required to process the application, and the number of applications may be used in generating a billing report. In addition, if prepaid billing is supported, then the Billing Manager may generate an accounting request to the carrier to properly decrement the subscriber's prepaid billing account. After the billing report has been generated and the appropriate parameters logged, the Billing Manager returns.

From the foregoing it will be appreciated that, although specific embodiments of the invention have been described herein for purposes of illustration, various modifications may be made without deviating from the spirit and scope of the invention. For example, one skilled in the art will recognize that the methods and systems discussed herein are applicable to provisioning applications across any network, wired or wireless, or even a plurality of such networks. One skilled in the art will also recognize that the methods and systems discussed herein are applicable to differing protocols, communication media (optical, wireless, cable, etc.) and subscriber devices (such as wireless handsets, electronic organizers, personal digital assistants, portable email machines, game machines, pagers, navigation devices such as GPS receivers, etc.). Also, all of the above U.S. patents, patent applications and publications referred to in this specification, including U.S. Provisional Application No. 60/253,674, filed on Nov. 28, 2000, and entitled “Method and System for Maintaining and Distributing Wireless Applications;” U.S. Provisional Application No. 60/296,901, filed on Jun. 8, 2001, and entitled “Method and System for Maintaining and Distributing Wireless Applications;” U.S. Provisional Application No. 60/271,661, filed on Feb. 26, 2001, and entitled “Method and System for Packet Level Billing in Wireless Application Environments,” and U.S. Provisional Application No. 60/296,872, filed on Jun. 8, 2001, and entitled “Method and System for Providing Customizable Logging Messages in a Wireless Application Environment” are incorporated herein by reference, in their entirety. Aspects of the invention can be modified, if necessary, to employ methods, systems and concepts of these various patents, applications and publications to provide yet further embodiments of the invention. In addition, those skilled in the art will understand how to make changes and modifications to the methods and systems described to meet their specific requirements or conditions.

1. A method in a computer-based environment for preparing content to be deployed on a target wireless device, comprising:
provisioning the content for the target device;
verifying that the device supports execution of the content by comparing the device capabilities to the content requirements; and
providing the verified and provisioned content.

2. The method of claim 1, further comprising causing the prepared content to downloaded to the target device over a wireless transmission medium.

3. The method of claim 2 wherein the content is requested by a subscriber of a carrier to the computer-based environment over a wireless transmission medium.

4. The method of claim 1 wherein the provisioning comprises at least one of:
inspecting the content;
optimizing the content; and
instrumenting the content.

5. The method of claim 4, the inspecting further comprising at least one of:
determining whether the content contains malicious code;
determining whether the content contains banned code; and
determining whether the content contains designated API.

6. The method of claim 5 wherein the API is at least one of packages, classes, methods, and fields.

7. The method of claim 4 wherein the inspecting is performed using an application filter.

8. The method of claim 7 wherein the application filter specifies a list of criteria to be filtered and a target.

9. The method of claim 8 wherein the criteria is an API.

10. The method of claim 8 wherein that target is at least one of a specified client, device type, content identifier, and global definition.

11. The method of claim 4, the optimizing further comprising at least one of:
reducing the size of variable names;
modifying instructions to more efficient instructions; and
removing unused code.

12. The method of claim 4, the instrumenting further comprising inserting code that implements at least one of a billing policy, a usage policy, a notification, and an automatic content update mechanism.

13. The method of claim 4 wherein the instrumenting is accomplished at a byte-code level of content examination.

14. The method of claim 1 wherein the provisioning provides code to support billing policies.

15. The method of claim 14, the billing policies further comprising at least one of subscription based billing, trial use, download based billing, transmission based billing, and prepaid billing.

16. The method of claim 14 wherein the billing policies are provided by a wireless carrier infrastructure.

17. The method of claim 1 wherein the content is provisioned for a requester, and the verifying further comprising at least one of:
comparing the API used by the content to the API supported by the target device;
determining whether the requestor is authorized to use the content; and
determining whether the content is banned.

18. The method of claim 17 wherein determining whether the requestor is authorized determines whether the requester has sufficient funds in a prepaid billing account to use the content.

19. The method of claim 1 wherein the verification is accomplished using profile management.

20. The method of claim 19 wherein the profile management defines profiles for at least one of a subscriber, device type, and content.

21. The method of claim 1 wherein the content is Java-based.

22. The method of claim 1 wherein the environment is integrated with a wireless carrier infrastructure.

23. The method of claim 1 wherein the content preparation provides walled-garden provisioning.

24. The method of claim 1, the computer-based environment including a network, wherein the provisioning supports the designation of the content to be prepared through browsing to a location on the network.

25. The method of claim 1 wherein the network is the Internet.

26. The method of claim 1 wherein the preparation process takes into account preferences of a requester of the content.

27. The method of claim 1 wherein attributes that control the provisioning are specified through website administration.

28. The method of claim 1 wherein attributes that control the verification are specified through website administration.

29. The method of claim 1 wherein the content contains at least one of text, graphics, audio, and video.

30. A network-based transmission medium containing content that has been provisioned and verified specifically for a target wireless device.

31. The transmission medium of claim 30 wherein the content is transmitted to the target wireless device.

32. The transmission medium of claim 30 wherein the provisioned content has been at least one of inspected, optimized, and instrumented.

33. The transmission medium of claim 32 wherein inspected content has been inspected to determine that it does not contain specified code, API, or other criteria.

34. The transmission medium of claim 32 wherein the inspected content has been inspecting using dynamically specifiable application filters.

35. The transmission medium of claim 34 wherein the application filters specify a list of criteria to be filtered and a target.

36. The transmission medium of claim 32 wherein the instrumented content contains code to implement at least one of a billing policy, usage policy, notification, and automated content update mechanism.

37. The transmission medium of claim 32 wherein the instrumented content has been instrumented at the byte-code level.

38. The transmission medium of claim 30 wherein the provisioned content contains code to automatically implement a billing policy for the content.

39. The transmission medium of claim 30 wherein the content has been verified by determining at least one of a user of the target device is authorized to receive the content, the target device supports the API used by the content, and the content has not been banned.

40. The transmission medium of claim 30 wherein the content has been verified by comparing aspects of the content to stored profiles.

41. The transmission medium of claim 30 wherein the network is connected to a wireless carrier infrastructure.

42. The transmission medium of claim 30 wherein the content is Java-based.

43. The transmission medium of claim 30 wherein the network is the Internet.

44. The transmission medium of claim 30 wherein the content contains at least one of text, graphics, audio, and video.

45. A computer-readable memory medium containing instructions for controlling a computer processor to prepare content for deployment on a target device, by:
provisioning the content for the target device; and
verifying that the target device supports execution of the provisioned content without executing the provisioned content on the device.

46. The computer-readable memory medium of claim 45 wherein the target device is a wireless device.

47. The computer-readable memory medium of claim 45, wherein the instructions further comprise causing the prepared content to downloaded to the target device over a wireless transmission medium.

48. The computer-readable memory medium of claim 45, the provisioning further comprising at least one of:
inspecting the content;
optimizing the content; and
instrumenting the content.

49. The computer-readable memory medium of claim 48, the inspecting further comprising at least one of:
determining whether the content contains malicious code;
determining whether the content contains banned code; and
determining whether the content contains designated API.

50. The computer-readable memory medium of claim 48 wherein the inspecting is performed using an application filter.

51. The computer-readable memory medium of claim 48, the instrumenting further comprising inserting code that implements at least one of a billing policy, a usage policy, a notification, and an automatic content update mechanism.

52. The computer-readable memory medium of claim 48 wherein the instrumenting is accomplished at a byte-code level of content examination.

53. The computer-readable memory medium of claim 45 wherein the provisioning provides code to support billing policies.

54. The computer-readable memory medium of claim 53, the billing policies further comprising at least one of subscription based billing, trial use, download based billing, transmission based billing, and prepaid billing.

55. The computer-readable memory medium of claim 45 wherein the content is provisioned for a requester, and wherein the verification further comprises at least one of:
comparing the API used by the content to the API supported by the target device;
determining whether the requestor is authorized to use the content; and
determining whether the content is banned.

56. The computer-readable memory medium of claim 55 wherein determining authorization of the requestor determines whether the requester has sufficient funds in a prepaid billing account to use the content.

57. The computer-readable memory medium of claim 45 wherein the verification is accomplished using profile management.

58. The computer-readable memory medium of claim 45 wherein the content is Java-based.

59. The computer-readable memory medium of claim 45 wherein the provisioning supports the designation of the content to be prepared through browsing to a location on a network.

60. The computer-readable memory medium of claim 45 wherein the content contains at least one of text, graphics, audio, and video.

61. A computer-based content deployment system for provisioning content for a target device, comprising:
verification manager that verifies that the content is authorized and the target device supports resources needed by the content; and
provisioning manager that provisions the content according to the target device by at least one of inspecting the content, optimizing the content, and instrumenting the content.

62. The deployment system of claim 61 wherein the provisioning manager further comprises at least one of:
subscriber verifier;
device verifier; and
application verifier.

63. The deployment system of claim 62 wherein the subscriber verifier determines whether a subscriber of a wireless carrier service is authorized to use the content.

64. The deployment system of claim 62 wherein the device verifier determines whether the target device supports an API required by the content.

65. The deployment system of claim 62 wherein the application verifier determines whether the content is banned.

66. The deployment system of claim 61 wherein the target device is a wireless device.

67. The deployment system of claim 61 wherein the deployment system is integrated with a wireless carrier computer system.

68. The deployment system of claim 61 wherein instrumenting the content provides support for at least one of a billing policy, a usage policy, a notification, and an automatic content update mechanism.

69. The deployment system of claim 61, further comprising: billing manager that provides support for provisioning the content according to a billing policy.

70. The deployment system of claim 69 wherein the billing policy is one of subscription base billing, trial use, download based billing, transmission based billing, and prepaid billing.

71. The deployment system of claim 61 wherein the designation of the content to be provisioned is determining by browsing to a location on a network.

72. The deployment system of claim 61 wherein the content is Java-based.

73. The deployment system of claim 61 wherein the content contains at least one of text, graphics, audio, and video.
